(19) United States
(12) Patent Application Publication
(10) Pub. No.: US 2015/0229698 A1
(43) Pub. Date: Aug. 13, 2015

(54) Crowd Sourced or Collaborative Generation of Issue Analysis Information Structures

(71) Applicant: Joseph G. Swan, Hermosa Beach, CA (US)

(72) Inventor: Joseph G. Swan, Hermosa Beach, CA (US)

(21) Appl. No.: 13/306,498

(22) Filed: Nov. 29, 2011

Related U.S. Application Data
(60) Provisional application No. 61/417,860, filed on Nov. 29, 2010.

(51) Int. Cl. H04L 29/08; H04L 29/06

(52) U.S. Cl. CPC H04L 67/10; H04L 67/42

(57) ABSTRACT

A system for analyzing issues includes: (a) a server providing an interactive site on a communications network; and (b) multiple user devices communicating with the server across the communications network. The server stores multiple data structures, each including hierarchically arranged active nodes that together present analysis information pertaining to a different issue. Each of the data structures includes a top active node that corresponds to the issue to which the data structure pertains. Users, through the user devices, submit proposed additional nodes to the server. Each is submitted as a potential child node to a previously existing active node in one of the data structures and includes a discussion point pertaining to such previously existing active node. The server accepts, in accordance with a specified criterion, a subset of the proposed additional nodes to be added as active nodes, thereby extending the corresponding hierarchical structures.

This application claims the benefit of U.S. Provisional Patent Application Ser. No. 61/417,860, filed on Nov. 29, 2010, and titled “Crowd-Sourced Debate for Constructing Analytic Trees”, which application is incorporated by reference herein as though set forth herein in full.

### FIELD OF THE INVENTION

The present invention pertains to systems, methods and techniques, e.g., implemented across the Internet, through which a large number of individuals can collaboratively discuss, analyze and debate different issues or questions.

### BACKGROUND

A variety of different websites and other forums for debating issues currently exist. However, the present inventor has discovered that the conventional forums often do not lead to any consensus and, frequently, are not very effective at helping people obtain a clearer understanding of the issues being debated.

### SUMMARY OF THE INVENTION

The present invention addresses this problem by providing novel systems, methods and techniques through which a large number of individuals can collaboratively discuss, analyze and debate different questions or issues. In the preferred embodiments, for each such issue under consideration, there is created at least one analytic tree structure that contains, in a hierarchical form, the arguments, points, assertions, and items of information pertaining to the issue (typically referred to herein as “points” or “discussion points”), together with lower-level points supporting or refuting the individual (e.g., each of) the higher-level points. These analytic trees preferably can evolve over time and potentially even interconnect with each other, e.g., where there are overlapping considerations, points, information or core values, providing lasting data structures that allow the current best points on each side (or all sides) of an issue to be quickly and easily identified.

Thus, one embodiment of the invention is directed to a system for analyzing issues, which includes: (a) a server providing an interactive site on a communications network; and (b) multiple user devices communicating with the server across the communications network. The server stores multiple data structures, each including hierarchically arranged active nodes that together present analysis information pertaining to a different issue. Each of the data structures includes a top active node that corresponds to the issue to which said data structure pertains. Users, through the user devices, submit proposed additional nodes to the server. Each of the proposed additional nodes is submitted as a potential child node to a previously existing active node in one of the data structures and includes a discussion point pertaining to such previously existing active node. The server accepts, in accordance with a specified criterion, a subset of the proposed additional nodes to be added as active nodes, thereby extending the corresponding hierarchical structures.

The foregoing summary is intended merely to provide a brief description of certain aspects of the invention. A more complete understanding of the invention can be obtained by referring to the claims and the following detailed description of the preferred embodiments in connection with the accompanying figures.

### BRIEF DESCRIPTION OF THE DRAWINGS

In the following disclosure, the invention is described with reference to the attached drawings. However, it should be understood that the drawings merely depict certain representative and/or exemplary embodiments and features of the present invention and are not intended to limit the scope of the invention in any manner. The following is a brief description of each of the attached drawings.

FIG. 1 is a block diagram of a system according to according to a representative embodiment of the present invention.

FIG. 2 is a block diagram illustrating submissions of issues that are proposed for analysis and then selection of the submitted issues for active analysis.

FIG. 3 illustrates the top level of an analytic tree structure according to a representative embodiment of the present invention.

FIG. 4A illustrates a representation of a submitted discussion point, and FIG. 4B illustrates the highlighting of a relevant portion of that discussion point.

FIG. 5 is a block diagram illustrating the derivation of a discussion point from a previously submitted discussion point.

FIG. 6 illustrates the second level of an analytic tree structure, underneath a single top-level discussion point node.

FIG. 7 illustrates the linking of a node to supplementary information.

FIG. 8 is a block diagram showing the general structure of a discussion point node according to a representative embodiment of the present invention.

FIG. 9 is a block diagram illustrating the concept of relevance of one point to one or more other points.

FIG. 10 illustrates an exemplary main issue page for an issue-analysis site according to a representative embodiment of the present invention.

FIG. 11 illustrates an issue-introduction page of the site.

FIG. 12 illustrates a preliminary-analysis or scratch-pad page of the site.

FIG. 13A illustrates a two-column analysis page for an issue; and FIG. 13B illustrates a two-column analysis page for a discussion point.

FIG. 14 illustrates a two-column analysis page of the site, with rating in process.

FIG. 15 illustrates the two-column analysis page of the site after rating has taken place.

FIG. 16 illustrates a one-column analysis page of the site for an active discussion point.

FIG. 17 illustrates an analysis page of the site for a pending discussion point.

FIG. 18 illustrates a page for creation or editing of a new discussion point.

FIG. 19 illustrates a page for creation or editing of a new discussion point, with the ability to link to other existing discussion points.

FIG. 20 illustrates a page for discussing or commenting on a pending discussion point in less formal manner.

FIG. 21 illustrates a block diagram showing certain interactions between a user and the server according to a representative embodiment of the present invention.

### DESCRIPTION OF THE PREFERRED EMBODIMENT(S)

For ease of reference, the present disclosure is divided into sections. The general subject matter of each section is indicated by that section's heading.

### System Overview.

In the preferred embodiments of the present invention, large numbers of individuals (users) interact, through their individual user devices, with a central server or a common site (e.g., a website) across either a publicly accessible communications network, such as the Internet, or a private communications network, such as a local area network (LAN), a wide area network (WAN or a virtual private network (VPN). More preferably, anybody who agrees to abide by, and does in fact abide by, the site's rules is allowed to participate (e.g., by contributing to the analysis of individual issues) or simply review the analyses that have been put to be constructed by other users. In any event, a site according to the preferred embodiments of the present invention preferably is publicly accessible. However, in some embodiments (e.g., for in-house use by a particular entity) a private version of one of the kinds of sites described herein is implemented (e.g., for facilitating brainstorming and subsequent decision-making by teams of corporate executives and/or professionals).

In some cases, depending upon the specific embodiments and/or the roles taken up by individual users of the site, such users can have the ability: to propose issues to be analyzed; to vote on, or otherwise provide feedback regarding, proposed issues for the purpose of determining which one(s) will in fact be analyzed; to propose discussion points pertaining to an issue being analyzed or pertaining to another discussion point that previously has been made; to propose modifications to (or alternate versions of) discussion points previously proposed or submitted by others (e.g., pending or active discussion points); to submit or identify information in support of, or otherwise related to, issues and/or previously submitted discussion points; to vote on, or otherwise provide feedback regarding, whether a proposed discussion point (sometimes referred to herein as a pending discussion point or a pending discussion point node) should be included within an overall analytic tree (as an active discussion point or active discussion point node); and/or to vote on other matters, such as whether (or the extent to which) a discussion point is believed to be accurate (e.g., supported by its child discussion points), whether (or the extent to which) a submitted discussion point supports or refutes the particular discussion point or issue under which it was submitted, and/or whether (or the extent to which) a submitted discussion point is relevant to the particular discussion point or issue under which it was submitted.

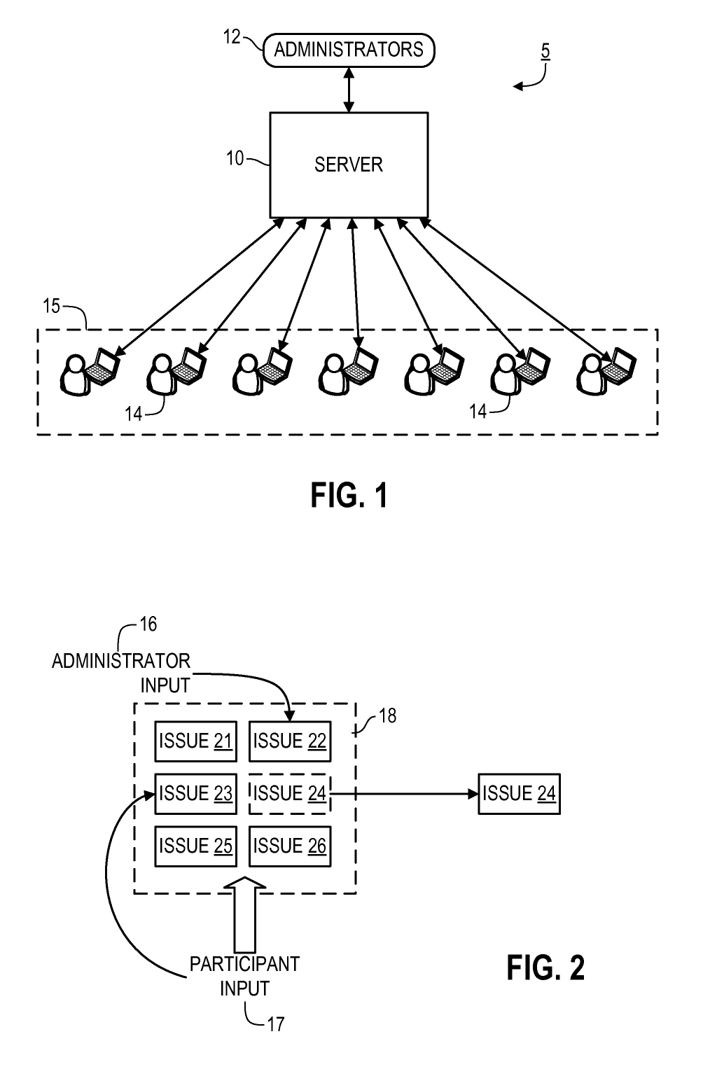

Referring to FIG. 1, a system 5 according to the present invention preferably includes a central server 10 that manages interactions among the various users and provides a platform through which submitted comments, discussion points, ratings, votes and other kinds of messages and information can be managed and more easily incorporated into the analytic trees, information networks and hierarchical structures contemplated herein. The present invention generally contemplates two general types of users: (1) administrators 12 who manage the system 5 and preferably are primarily or wholly responsible for setting up the rules for constructing such analytic structures, for applying and enforcing such rules, for moderating discussions pertaining to the issues being analyzed, for resolving any disagreements about what is to be included within the analytic tree structures, and for establishing criteria for determining the order in which various discussion points are to be presented to a user; and (2) general participants 14 who preferably provide most of the discussion points, informal comments and other items and substantive content for the system 5 and who preferably also help to evaluate the merits of submitted discussion points and other items, e.g., through one of the rating and/or voting processes described herein. Preferably, the administrators 12 have the same rights as the general participants 14, along with some additional administrative rights, and therefore also can be considered to be general participants 14 when engaging in activities that do not require administrative privileges. In the preferred embodiments, the administrators 12 include system administrators who are generally responsible for the entire system 5 and issue moderators who moderate the analyses and discussions pertaining to individual issues. More preferably, the system administrators assign individual issues to individual moderators and then receive and act on feedback from the general participants 14 regarding the performance of such moderators. All interactions performed by the administrators 12 or the participants 14 with the server 10 that are referenced herein are performed through such users' user devices (e.g., computers, smartphones, etc.).

As used herein, the “community” 15 includes all the general participants 14 (which, as noted above, preferably includes the administrators 12 when functioning outside the scope of their administrative rights and/or duties). In the preferred embodiments, the community 15 as a whole typically provides all or substantially all of the discussion points and information used to construct the tree structures and is involved in filtering and/or directing such submitted discussion points to the appropriate positions within such tree structures. Although only seven general participants 14 are illustrated in FIG. 1, it should be understood that there ordinarily will be thousands, tens of thousands, hundreds of thousands, millions, tens of millions or even hundreds of millions of general participants 14 in the community 15. Ordinarily, there will be a substantially smaller number of administrators 12, preferably with most, all, or substantially all of the administrators 12 having been chosen (and, in some cases, removed), exclusively or in part, by all, a majority of or at least a substantial part of the community 15 (either directly and/or indirectly, e.g., through voting processes and/or through their election of other administrators 12).

The individual general participants 14 preferably communicate digitally with the server 10 using electronic devices, such as computers, wireless telephones (e.g., smartphones) or other user devices, across one or more publicly accessible networks, such as the Internet. However, in certain embodiments the system 5 is privately controlled (e.g., by a single commercial enterprise or by any other entity) or otherwise restricted, in which case such user devices preferably communicate across a private network (such as a LAN, WAN or VPN). Still further, communications also can be effected in any other manner, e.g., using voice communications across the analog public switched telephone network, or PSTN (e.g., using speech recognition to convert voice messages into a digital textual form) or even via physical submissions of information through US mail or other delivery services (e.g., using scanning and optical character recognition to convert such submissions into a digital textual form). The administrators 12 preferably also can communicate with the server 10 using any of the foregoing methods. However, because the administrators 12 sometimes will be geographically close to server 10 and typically will have greater access rights, at least some of them might be more likely to communicate via a local area network (LAN) or a wide area network (WAN). It should be noted that server 10 can be implemented as a single server device or as a collection of interconnected server devices, which can include different types of server devices (such as separate network server devices, load balancers and/or storage server devices), and which can geographically be dispersed, but which preferably function together as a single logical entity.

In the preferred embodiments, at least some (and in some cases all) of the individual general participants 14 are required to register with the server 10 in order to reduce fraudulent activity and to allow the system 5 and/or the administrators 12 to evaluate the quality of participation among the different general participants 14 (e.g., in terms of a pattern of submitting and/or supporting high-quality discussion points and relevant information as opposed to simply continually endorsing a partisan viewpoint without regard for the underlying merits of the specific discussion points and/or information under consideration). At the very least, registration preferably is encouraged, e.g., by providing greater rights to those general participants 14 who register and then demonstrate quality participation. In this regard, in the preferred embodiments of the invention the general participants 14 and/or the administrators 12 are assigned to participation levels based on their amount and quality of participation. In certain cases ratings and/or votes submitted by users having a higher participation level are weighted more heavily than those submitted by users having a lower participation level. When the following discussion refers to weighted combinations of ratings or votes, unless specified otherwise such weightings are based on the users' participation levels. Also, in the preferred embodiments, the administrators 12 are required to register and, more preferably, to register under their real names, so that there is greater transparency regarding the operation of the system 5.

### Issue and Discussion Points; Creation of Analytic Structures.

One of the tasks that preferably is performed within system 5 is the selection of one or more issues to be analyzed. As shown in FIG. 2, in the preferred embodiments, both the system administrators 12 and the general participants 14 preferably have input, 16 and 17, respectively, in the performance of this task. In certain embodiments, either the administrators 12 or the general participants 14 can submit proposed issues (e.g., issues 22 and 23, respectively) for analysis, thereby creating a set of proposed (or pending) issues 18. Then, the issue 24 actually to be analyzed (the active issue) is selected from the set of pending issues 18, either using the same or different selection criteria based on whether a proposed issue was submitted by an administrator 12 or a general participant 14.

The selection of pending issues to be analyzed (i.e., to become active issues) can be performed, e.g., based solely on the popularity of the issues. For example, in certain embodiments a single weekly or daily vote of the community 15 is conducted and the pending issue(s) receiving the most votes (on a weighted or unweighted basis) are selected to become active issues. In other embodiments, active issues are selected based on the amount and/or quality of activity generated by (e.g., comments received in relation to) the pending issues. Alternatively, a tiered approach can be used, e.g., in which pending issues that achieve a threshold level of popularity and/or activity (e.g., in terms of absolute numbers or relative rank) are elevated to a smaller selection pool, and then a weekly or daily vote, limited to those pending issues in the selection pool, is conducted to select the active issues to be analyzed. In some embodiments, the administrators 12 have greater rights in determining which issues 24 are selected for analysis, the general participants 14 having higher dissipation levels (e.g., based on the amount and/or quality of their past participation) have greater rights in selecting the issues 24, and/or the individuals submitting a proposed issue are required to submit an article discussing the issue and/or its importance. In other embodiments, all issues submitted (or at least those that comply with the established rules) are accepted and analyzed, and the resulting discussion points and information are incorporated into an analytic tree structure in accordance with the methods described herein.

However, an approval process is preferred at least for the purpose of making any refinements in the statement of the issue and/or its introductory article. In this regard, during the pending phase, participants 14 preferably can suggest changes to the statement of the issue or to its introductory article in an attempt to put it in the best form for analysis. A similar vetting process is discussed below with respect to pending discussion points, and any or all of the same considerations also can apply to the vetting of pending issues.

In the preferred embodiments, the active issues are available for formal analysis as described below. However, in the preferred embodiments, some of the active issues are only available to those users who choose to become involved in the analysis as contributors. In this regard, there ordinarily will be two kinds of users: (1) consumers who are only interested in reading about or exploring issues that have been analyzed and (2) contributors who want to be actively involved in the analysis of one or more issues. To accommodate these two kinds of users, the preferred embodiments accommodate a browsing mode and a contribution (or edit) mode. More preferably, when an issue initially becomes active, it is only available for viewing and analysis in the contribution mode. Later, after a determination has been made that the analysis has been fairly well developed, a decision is made to publish the issue, at which point it is also available in the browsing mode.

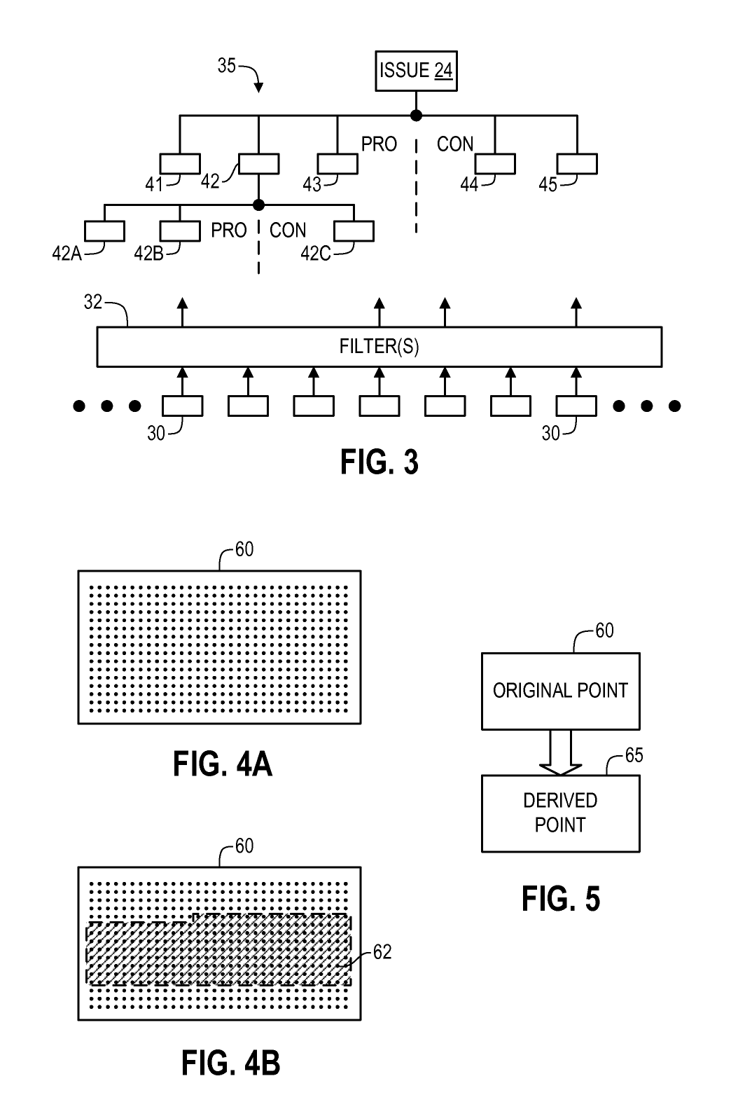

Once an issue 24 has been selected for active status, a stream of additional information pertaining to it begins to be received by the server 10. Referring to FIG. 3, this information can include discussion points 30 (e.g., including various assertions and supporting information) that have been proposed by the participants 14 for inclusion into a formal analytic tree structure 35 that is created for the issue 24, as well as informal comments pertaining to the overall issue 24 and/or to any previously submitted discussion point (active or pending). More preferably, each point in the analytic tree structure 35 can be analyzed through the submission of informal comments by the participants 14 and (preferably after some period of such informal analysis) through the submission of formal discussion points to be included as part of the structure 35. As with issues, each submitted discussion point preferably initially is assigned pending status and must be approved (or made active) before being incorporated into the analytic structures 35. For this purpose, the pending discussion points 30 preferably are subjected to a filtering process 32 so that some of them (or in some cases, parts of individual pending discussion points) are populated as active nodes (e.g., top-level nodes 41-45 or lower-level nodes 42A-C) into the analytic tree structure 35.

As exemplified by structure 35 in FIG. 3, for each active issue a data structure, including hierarchically arranged active nodes that together present analysis information pertaining to the issue, is created. The top active node (e.g., node 24 in structure 35) corresponds to the issue to which the data structure pertains.

Sometimes an issue will be framed as a binary yes/no (or pro/con) question, in which case the points or arguments (and their corresponding tree nodes) typically can be segregated based on whether they tend to support a “yes” conclusion (“pro”) or a “no” conclusion (“con”). For example, in FIG. 3 discussion points 41-43 support the pro side with respect to issue 24, while discussion points 44 and 45 support the con side. In addition, any of the participants 14 (any user, other than any potential exceptions, e.g., where a particular user has repeatedly violated the rules) preferably can propose adding a child node to each (or any) of discussion points 41-45 (or any other existing active node in analytic structure 35) to present the pro and con points with respect to such discussion point (or node), or to present any other kind of discussion point pertaining to such node (e.g., where such node is a multi-part node, as discussed below).

For example, in FIG. 3 discussion points 42A&B are on the pro side of discussion point (or node) 42 (meaning that they tend to support the validity or truth of the discussion point), while discussion point 42C is on the con side of discussion point 42 (meaning that it tends to refute the validity or truth of discussion point 42).

Generally speaking, the discussion points at the same level (e.g., points 41-45) are somewhat (or entirely) independent of each other, meaning that they address distinct considerations. If one wished to attempt to rebut a particular pro discussion point, rather than proposing to add a con discussion points at the same level, it ordinarily would be best to propose adding a child con discussion point underneath the disputed discussion point.

Although not illustrated in the drawings, in certain cases, the child discussion points (or nodes) underneath a particular node cannot be easily categorized (at least at the outset) as simply pro or con. In such a situation, for example, the top-level nodes 41-45 shown in FIG. 3 just reflect the various main considerations pertaining to the issue 24. Later, if it becomes appropriate, any or all of such nodes can be tagged as pro or con. In the preferred embodiments any node can contain a “simple” issue or discussion point that can be analyzed with respect to the extent to which there is evidence or arguments to support or refute it, or else can contain a “multi-part” or “group” discussion point that can have various sub-issues or sub-points underneath it. An example of a multi-part issue is: how should we balance the federal budget? Its immediate child nodes (e.g., sub-issues) could then include, e.g., raising a certain tax, raising an existing tax on a certain segment of the population, or cutting spending on a particular program. An example of a multi-part discussion point is one that can be broken down into different levels or degrees (e.g., with a parent node holding the assertion that average global temperatures are increasing and with the children nodes holding assertions about the amount of such increases, such as less than 0.1° per year, approximately 0.5° per year, approximately 1° per year, etc.). Generally speaking, any node in an analytic structure according to the present invention can be simple or multi-part.

Some of the pending discussion points 30 that have been submitted by the general participants 14 will be directly relevant to the issue 24 at hand and therefore should be incorporated into the tree structure 35. In other cases, a proposed discussion point 30: might not have sufficiently direct logical relevance (e.g., off-topic remarks or personal attacks), might need to be parsed out into two or more relevant discussion points and/or related assumptions before being included, or otherwise will be inappropriate for direct inclusion (e.g., because it constitutes a specific factual discussion point for which no credible evidence has been provided in support, or because a very similar or identical discussion point already has been incorporated into the tree structure 35). As a result, a filtering mechanism 32 preferably is used to distinguish between pending discussion points that should be incorporated into the tree structure 35 and pending discussion points that should not (at least not before further analysis and/or revision).

This filtering mechanism 32 can be: based entirely on votes of the general participants 14 (which can be weighted, e.g., based on amount and/or quality of past participation, or unweighted, such as a vote conducted across at least 20, 50, 100, 500 or 1,000 users, or a vote across a specified percentage of the community 15, such as at least 5%, 10% or 20% of the community 15); based on consensus reached among the general participants 14 in a less-formal comments or discussion page; based entirely on the judgment of the administrators 12 (or a single administrator 12 or administrative user); based on the decision of the administrators 12 (or a single administrator 12) after considering the informal comments made by the community 15 as a whole; or based on any desired combination of these considerations. Given the large number of decisions that must be made, in certain embodiments it is preferable to have the administrators 12 perform an initial stage of the filtering 32 and placement of the surviving pending discussion points 30 into the analytic tree structure 35 (e.g., based on the general consensus reached within the community 15), with the community 15 then having the ability to challenge any decisions made by the system administrators 12 (e.g., with a sufficient number and/or percentage of votes). In other embodiments, the community 15 provides the initial filtering (e.g., with some minimum number and/or percentage of votes being required for a discussion point 30 to survive), and then the system administrators 12 perform any additional filtering 32 and direction of the surviving discussion points 30 into the tree structure 35, again with the ability of the community 15 to challenge any such decisions.

The precise mechanism used preferably attempts to achieve a balance between as much participation by the whole community 15 as possible, on the one hand, and expedience and intellectual integrity, on the other. As to this latter consideration, the filtering mechanism 32 preferably should eliminate or significantly reduce the possibility that highly partisan voting blocs can either suppress valid points pertaining to the issue 24 under consideration or populate the tree structure 35 with spurious discussion points that might tend to obscure the truly relevant ones. At the same time, any points that are at least potentially valid preferably should be considered, e.g., incorporated into the analytic tree structure 35 and then formally analyzed or hashed out in a related less-formal comments or discussion page to determine what, if anything, should be incorporated into the tree structure 35 for more-formal analysis. In this regard, it currently is preferred to use the informal analysis process of a comments page for the purpose of distilling submitted statements and arguments down to truly relevant discussion points and related assumptions, stated in as brief a manner as possible, before incorporating such discussion points into the tree structure 35 for formal analysis. In other words, in the preferred embodiments the informal comments/discussion process is used to put the pending discussion points into the best possible clear and logical form before making them active discussion points (part of the analytic tree structure 35).

It is noted that in the preferred embodiments, one of the main goals of the analytic process and the resulting analytic tree structure 35 ordinarily is not to reach a definitive answer on any issue 24, or even to definitively resolve any of the discussion points pertaining to the issue 24, but rather to assemble all of the relevant discussion points into an easily understandable format where it is possible to zoom-in on any desired point(s) to obtain any level of desired detail. For this reason, the filtering mechanism 32 of the preferred embodiments preferably is biased toward allowing questionable discussion points to be included (albeit in their best form possible, after considering all of the comments made in informal discussions). Then, a substructure underneath each included discussion point presents all the information and sub-points pertaining to it. On the other hand, as noted above, if too many questionable points are included, the most relevant points might be lost in the clutter.

One way to address this problem is to limit discussion points and supporting information that are included within the analytic tree structure 35 to only those that have been shown to have a minimum threshold level of support (e.g., in terms of the number or percentage of the community 15 that supports including it or in terms of a minimum amount of evidentiary and/or reasoned argument support). Another is to include all potentially relevant discussion points and then assign a score (e.g., the strength score discussed below) to each based on the amount of support that has been established for it (e.g., how likely it is that the discussion point is likely to be true or valid) and/or based on how relevant the discussion point is to the discussion point represented by its immediate parent node; then, the strongest discussion points (e.g., based on the indicators of support and relevance) can be displayed first, or otherwise highlighted.

Either or both of the foregoing approaches can be employed in the various embodiments of the present invention. However, given that storage is relatively inexpensive and that one of the main considerations is to summarize all of the most relevant points in a concise form, it currently is preferred to err on the side of inclusion but to rank the discussion points that have been made based on relevance and demonstrated support. In this way, an individual user has the option of reviewing discussion points that have been determined to be weaker but, at the same time, those presumably weaker discussion points will not unduly distract one's attention from the discussion points that have been deemed to be stronger. In addition, because the analytic tree's structure 35 evolves over time, discussion points that currently are considered to be less relevant or to have less factual support can be elevated to a higher position in the future (e.g., as evidence, circumstances, understanding and/or attitudes change).

In any event, the main focus of the present disclosure is not necessarily the evaluation of the points incorporated into the analytic tree structures 35, but rather the generation of such tree structures 35. As noted above, for this purpose it is preferred to err on the side of over-inclusiveness. Within this context, preferably only clearly non-relevant discussion points, or points that are redundant of existing discussion points, are filtered out.

As indicated above, a single discussion point submitted by a general participant 14 potentially can include both a logically relevant portion and irrelevant remarks or information. However, a main goal of the preferred embodiments is to construct, for each issue 24 under consideration, an analytic structure 35 that presents the relevant points and supporting information as concisely as possible. For this reason, mechanisms preferably are provided (e.g., within filter 32) to extract only the relevant points and information from submitted pending discussion points.

In certain embodiments, the entire community 15 is responsible for the first level of filtering, i.e., for recognizing/formulating potentially relevant discussion points in the first instance. One approach is for the community 15 to simply vote on or rate any pending discussion point that is submitted, e.g., by clicking on a user interface element indicating whether (or the extent to which) it is a relevant point and/or a point that is supported, with the results then being combined using any of the weighted or non-weighted techniques described herein, and with only those discussion points receiving a threshold level of relevance and/or support ratings being elevated to the next level of consideration.

However, prior to doing so, he often is desirable to consider other (alternate) versions of the same general discussion point. For example, in situations where a submitted pending discussion point 60, as shown in FIG. 4A, has both valid and potentially invalid portions, another general participant 14 (i.e., one that did not submit the original discussion point 60) preferably has the ability to highlight just a portion 62 of the discussion point 60 (e.g., as shown in FIG. 4B) that he or she believes to be the valid portion and then indicate that only that portion should be submitted for a vote (e.g., so that the community 15 as a whole can vote on the entire original discussion point 60 and separately can vote on just the highlighted portion 62, preferably after full debate and/or discussion).

Alternatively, in the preferred embodiments a general participant 14 can review a submitted pending discussion point 60 and then submit a derived discussion point 65 that eliminates portions of it (e.g., the portions believed to be irrelevant) and/or adds to the original 60 (e.g., by strengthening existing arguments), as illustrated graphically in FIG. 5. As an entirely new discussion point, this derived point 65 may be voted on separately and thereby elevated into the initially filtered set, typically instead of, but in some cases possibly in addition to, the original pending discussion point 60.

As noted above, it generally is preferable to have the system administrators 12 involved in the construction of the analytic tree structures 35. One of the main reasons for this preference is that it often can be difficult for a large group of people, such as community 15 as a whole, to create an organized and succinct structure. In certain embodiments, the community 15 as a whole first filters out the clearly irrelevant discussion points and portions thereof (e.g., by weighted or unweighted voting or rating) and then, from this initially filtered set, the system administrators 12 preferably perform the more-detailed work of constructing the tree structure 35, again with subsequent oversight from the community 15 as a whole. The community 15 preferably then provides the node and link rating information discussed herein. In other embodiments, the system administrators 12 initially draft the discussion points and determine where they belong within the analytic structure 35, based on informal comments made by the community 15, after which the community 15 discusses and refines those discussion points. In either event, in a system 5 according to the preferred embodiments, a significant amount of informal discussion (e.g., through a commenting board) preferably occurs (or is required or encouraged through established rules and guidelines) before even the first draft of a discussion point is prepared.

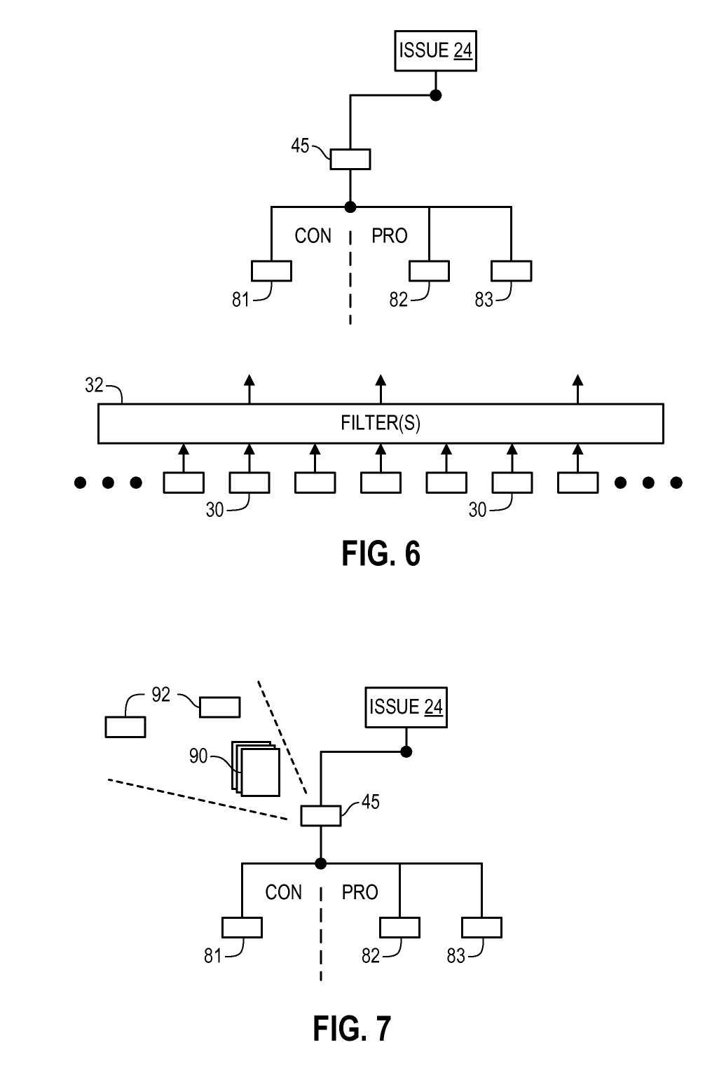

In the course of constructing an analytic tree structure 35, various situations can occur. As already noted above, additional structure can be built below a current bottom-level node, as sub-points are submitted by the community 15 and ultimately accepted as active nodes through the approval process. An example of this situation is illustrated in FIG. 6. In this regard, once an existing point (represented by corresponding node 45) has been made active, individual general participants 14 preferably can submit unstructured comments and/or proposed discussion points that relate to the original point (e.g., either in support of it or refuting it), e.g., through user interface elements associated with the corresponding node 45. For example, a sub-point preferably can be proposed by simply clicking on a main user interface element associated with node 45 and then clicking on a user interface element within the displayed page indicating that one wishes to create a (supporting or refuting) child discussion point, as discussed in greater detail below. A similar filtering process 32 then occurs in which the best arguments for and against the existing point 45 are used to create the substructure, e.g., nodes 81-83. This process can be repeated down to any number of levels.

In addition to building these structures downwardly, it preferably also is possible to create higher-level nodes from existing lower-level nodes. For instance, consider a situation in which five arguments have been made in support of an issue or point. Later, someone in the community 15 points out that three of those arguments actually support a broader argument, or can be grouped together under a broader point, or are otherwise related to each other in a meaningful way. In any such case, a new parent node (potentially a multi-part node) preferably is constructed to reflect the broader point and the nodes for the original three arguments are included as child nodes of the new node. More generally, it is anticipated that any given tree structure will change and evolve over time in a variety of different ways, e.g., as new arguments, new characterizations of those arguments, new supporting evidence and weaknesses in existing supporting evidence are brought to light.

As indicated above, an analytic tree structure preferably also can be supplemented in other ways, using different kinds of links and nodes, other than just support links and support nodes. For example, each node preferably contains a fairly concise summary of its respective point. However, as shown in FIG. 7, any node (e.g., node 45) preferably also can have other kinds of links, e.g., to nodes containing or referencing documents 90 that provide additional detail and/or explanation regarding the point 45 (which can be referred to as “explanations links”); to nodes 92 (e.g., in other analytic trees) that contain points that are similar to or in some manner related to the point 42 (which can be referred to as “related-point links”); to assumption or action-dependency nodes (as discussed in greater detail below); and/or to express any other kind of relationship between the points made in different nodes.

In addition to continual submissions of informal comments and formal discussion points, together with filtering activities by the community 15, the system 5 of the preferred embodiments preferably also includes hosting of periodic live shows (e.g., audio or video webcasts, radio shows and/or television shows) where the issues and points are discussed in real time. For example, the system administrators 12 preferably host one or more such shows per week, and general participants 14 who have submitted discussion points that have received the most votes (e.g., on a weighted basis), or are otherwise most active in the analysis of the particular issue, preferably are invited on as guests to discuss their positions, e.g., with call-ins from other members of the community 15. In certain cases, such shows focus on the most hotly debated issues that have arisen in the past week, e.g., the ones that have received the most comments and/or community votes (e.g., on a weighted basis). Alternatively, or in addition, such shows can be used to facilitate community interest in issues and/or particular points that the administrators 12 (or some group in the community 15) thinks should be more fully developed. In this manner, real-time discussions can occur, real-time rating (or voting) can take place, and the analytic tree structure 35 for a particular issue 24 can be developed (at least in part) in real time. Also, in certain embodiments, recorded copies of these shows (either in their entirety or just the portions pertaining to the particular point) are included in the supporting information 90 that can be linked to from the point or issue 24 to which they pertain.

As noted above, the filtering function 32 performed by the community 15 can involve a voting process, and different general participants 14 can have different weights assigned to their votes, e.g., depending upon their technical expertise and/or previously demonstrated level of objectivity (preferably encapsulated into a participation level that is assigned to the user). As to the latter consideration, even with respect to non-technical matters, it often will be desirable to weight different general participants' votes differently, e.g., based on their past history of interactions within the system 5. For example, general participants 14 who have a history of submitting accepted discussion points, who have demonstrated an ability to distinguish relevant logical arguments from irrelevant comments and/or who have been especially active while demonstrating a balanced viewpoint (e.g., an ability to consider both, or all, sides of an issue) preferably are assigned a higher participation level, so that their votes and/or ratings have greater weight. In addition, such individuals may be given additional rights, such as blog posts, the ability to comment about ongoing discussions in a separate section of the system's online site (e.g., website), or even to serve on committees that make executive decisions regarding the construction of the analytic tree 35, preferably again subject to oversight by the community 15 as a whole. As used herein, such oversight preferably means that the community 15 can overturn, force a reconsideration of, or force a higher-level administrative consideration of a previous administrative decision, e.g., in each case provided that a sufficiently large percentage and/or number of members in the community 15 vote for such an action to occur.

The analytic trees 35 generated in accordance with system 5 preferably evolve over time and potentially even interconnect with each other, as it becomes apparent that different basic discussion points apply to different issues 24 and/or different other discussion points (e.g., 41-45, 42A-C and 81-83), the latter potentially pertaining to the same or different issues 24.

In the preferred embodiments, each node is specific to a given point; therefore, any submitted discussion point that includes multiple relevant points preferably is divided into multiple corresponding different nodes. Because this function is mainly administrative in nature, in certain embodiments it is performed by the system administrators 12, a trusted general participant 14, or a committee of trusted general participants 14. In certain cases, it will not be possible to readily divide a discussion point into multiple different nodes. For example, a submitted peer-reviewed research article might pertain to multiple different points; in such a case, multiple different nodes preferably are generated, each citing the article in support (or refutation) of a different point and, ideally, each identifying the specific portion of the article that is relevant to the particular point.

In certain embodiments of the invention, anyone can be a consumer of the analysis produced by system 5. For this purpose, server 10 preferably provides a site (e.g., a website) where individuals can view lists of issues 24 that have been, or currently are still being, discussed and analyzed, together with an indication of the status of the discussion (e.g., whether a significant amount of discussion already has taken place or whether discussion is just getting underway) for each issue. In other embodiments, only those issues that have been significantly analyzed (e.g., as determined by the administrators 12), sometimes referred to herein as published issues, are presented (in such lists) to casual browsers.

From these lists, the user preferably can click on any desired issue 24, e.g., resulting in the display of the points pertaining to the top-level nodes (e.g., nodes 41-45). Thereafter, the user preferably can drill-down (or zoom-in) on the supporting and refuting arguments (e.g., corresponding to nodes 81-83) for each such point and/or link to supporting information (e.g., information 90). This process can be repeated down to any level of the tree structure 35. In addition, if the user feels that he or she has any input to provide, the user can become a general participant 14 (or contributing user), e.g., by selecting the contribution mode and then submitting his or her own informal comments, submitting proposed discussion points, voting on or rating existing discussion points, and/or proposing a new link between existing nodes (e.g., where the user believes that a point made in reference to one issue 24 is related to a different point made in reference to the same issue or a different issue). As such a user develops a history of quality participation, he or she preferably can progress toward having greater voting and/or other rights within the community 15 and, potentially, at some point being elected or otherwise selected as an administrator 12.

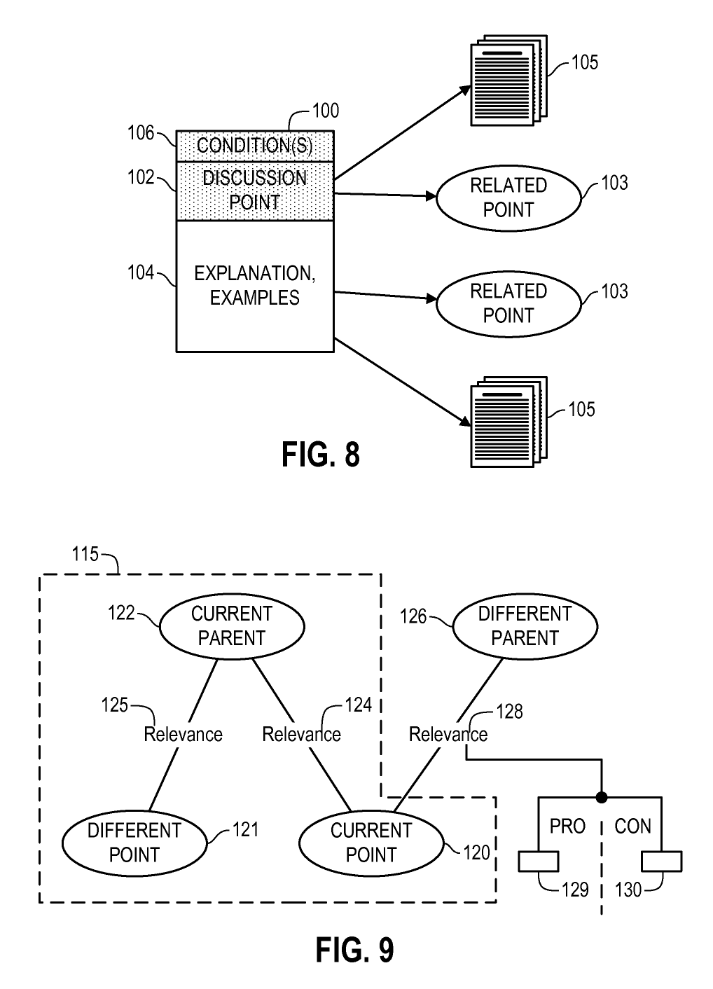

FIG. 8 illustrates the general structure of a discussion point node 100 according to a representative embodiment of the present invention. Included within node 100 is the actual discussion point 102 itself. In the preferred embodiments, each discussion point 102 is as concise as possible and, in certain embodiments, is limited to a maximum number of characters (e.g., a maximum of 200-400 characters). In addition, however, particularly because a discussion point 102 might include technical terms, references to deeper concepts or other information that might not be familiar to an average user, node 100 preferably also includes (or includes links to) explanatory information (e.g., including examples and/or analogies) 104. The discussion point 102 and/or its explanatory information 104 preferably can include one or more links to related (e.g., similar) discussion points 103 and/or related (e.g., background) information 105. Still further, in certain circumstances, the discussion point 102 might only be true if certain conditions 106 also are true and, if so, such conditions 106 (or at least links to them) preferably also are included within node 100. Such conditions 106 might include, e.g., factual assumptions and/or actions that must be taken (sometimes referred to herein as action dependencies).

FIG. 9 illustrates a portion 115 of an analytic tree structure for a current issue. Included within portion 115 is a current discussion point 120, a second (different) discussion point 121 (which is at the same level as current discussion point 120) and a parent node 122 for discussion points 120 and 121, with node 122 potentially being the overall issue or just a higher-level discussion point. Each of nodes 120 and 121 is linked to its parent node 122 by a support link having an associated relevance value 124 and 125, respectively. That is, irrespective of whether nodes 120 and 121 are intended to support or refute the discussion point within node 122, each can have a different degree of relevance with respect to the discussion point (or issue) within node 122. As also shown in FIG. 9, a discussion point (e.g., point 120) can be included within a node that is a child node of both its current parent 122 and another parent 126, with node 126 potentially being an entirely different issue, a different discussion point pertaining to the same current issue as nodes 120 and 122, or a different discussion point pertaining to an issue that is different than the current issue. In any event, current discussion point 120 ordinary will have a support link to node 126 with a relevance value 128 that is different than relevance value 124, e.g., as pointed out in the example discussed above.

In addition to analyzing support for each of the nodes in an analytic structure 35 (e.g., nodes 120 and 121 being support nodes that either support or refute the discussion point or issue in node 122), users preferably can analyze how relevant each child discussion point is to its parent (e.g., can analyze relevance values 124, 125 and 128) using a similar hierarchical structure. For instance, in the present example node 129 contains a discussion point tending to show that discussion point 120 is relevant to its parent node 126 (pro), while node 130 contains a discussion point tending to show that discussion point 120 is not relevant to its parent node 126 (con). Of course, although not expressly shown, more than two discussion points can be added at the same level and child discussion points can be added for each existing discussion point (e.g., point 129 and/or 130).

The discussion above refers to the ability of participants 14 to submit informal comments and formal analysis pertaining to any issue or discussion point within system 5. Informal comments are conventional unstructured writings that are typically arranged in the order in which they are submitted. Formal analysis including submission, refinement and acceptance of issues and discussion points; submission of ratings (preferably just for active discussion points and/or issues); submission of votes (preferably just for determining whether pending discussion points and/or issues should be made active); and/or submission of any other information related to adding, rating or ranking of nodes within any analytic structure 35.

### Ratings and Metrics.

In the preferred embodiments, for purposes of ranking discussion points the following items are considered: (1) some evaluation of the level of factual and/or reasoned analytical support that has been shown for the truth of, correctness of or likelihood of being true for a particular discussion point or, more generally, how confident one is that the discussion point is valid; and (2) the relevance of that point to its immediate parent in the analytic tree structure 35 (i.e., the next higher-level discussion point or the overall issue 24, as appropriate). For this purpose, users (e.g., any or all of the participants 14), through the user devices, preferably have the ability to submit ratings of at least the active nodes (e.g., any of such active nodes) within any of the analytic data structures 35 maintained by system 5. More preferably, such ratings include “support ratings”, indicating a degree to which the discussion point in the corresponding active node is believed to be supported, and “relevance ratings”, indicating a degree to which the discussion point in the corresponding active node is believed to be relevant to the discussion point or issue in a parent node for which the corresponding active node is a child node. In the preferred embodiments, users (e.g., any of the participants 14) can submit support value ratings for any discussion point within any analytic structure 35 and can submit relevance value ratings for any support link within any analytic structure 35.

As to the former, a “support value” reflects how likely it is that the point is in fact true and/or how strongly one should believe in it. Although this support value can be conceptualized as being on a scale of 0 to 100% or, alternatively, −100% to +100%), as discussed in greater detail below, for practical reasons the users preferably submit their ratings as a number of stars (e.g., from 0 to 5, representing whether the user believes the value is closer to 0, 20%, 40%, 60%, 80% or 100%, respectively, or from −5 to +5, representing whether the user believes the value is closer to −100%, −80%, −60%, −40%, −20%, 0, 20%, 40%, 60%, 80% or 100%, respectively) or in any other user-friendly manner.

For “simple” nodes, this support value preferably depends upon the “direction” in which its immediate child nodes point (e.g., whether its immediate child nodes support or refute the proposition) and is a function of the support values for those immediate child nodes. The referenced function for combining such support values, in turn, preferably reflects the importance or relevance of each immediate child node's discussion point to the current node's support value (e.g., how much weight the discussion point pertaining to one child node should have relative to the other child node discussion points), which is indicated by the relevance value assigned to the support link between the current node and the subject immediate child node. In some cases, typically where the discussion points in the immediate child nodes are independent of each other, the function will be a simple weighted average of the combined support and relevance values for the immediate child nodes. In other cases, it will be more complex, such as where the discussion points corresponding to two or more immediate child nodes must be true in order for them to support the discussion point represented by the parent node. In theory, each participant, when assigning a support value to a node (containing an issue or a discussion point), either explicitly or implicitly calculates or estimates the result of such a function, and by taking into account how well-supported and how relevant each child discussion point is to the present issue or discussion point. In addition, such a function can be explicitly specified by the administrators 12 or the community 15 as a whole for the purpose of automatically calculating a derived support value for any given node (e.g., using composite support and relevance values, calculated by combining the values submitted from the entire community 15, for the node's immediate children).

As indicated above, the immediate child points beneath a current discussion point can either support or refute that discussion point. This direction preferably is expressed as the sign of the relevance value (positive or negative). Therefore, a preponderance of supporting sub-points might lead to a positive support value, a preponderance of refuting sub-points might lead to a negative support value, and when the supporting and refuting sub-points are approximately balanced the support value might be close to zero. The direction in which a node points (e.g., whether it supports or refutes the proposition of its immediate parent node) often will be readily apparent, although in some cases its direction can be ambiguous or open to disagreement. The support value for each node typically will be derived from the support and relevance values for its immediate child nodes (if any) in the manner noted above.

Therefore, much of the most relevant analysis by the community 15 (whether implicit or explicit) preferably will focus on the appropriate support values for the very bottom-level nodes and, for any other node in the analytic tree 35, the appropriate function for combining the support values for its immediate child nodes in order to obtain the support value for the parent node. However, support values directly assigned by the community 15 and/or administrators 12 for mid-level and higher-level discussion points, particularly when compared to derived support values based on the support values for lower-level discussion points, also can be extremely useful, e.g., in comparison to be calculated (or derived) values, with a significant convergence potentially indicating either that one or more of the assigned functions should be modified or that the community 15 as a whole might not be adequately considering all of the relevant discussion points.

The community's discussions and analyses regarding appropriate support values for the bottom-level nodes can lead to the submission of additional discussion points (e.g., arguments and supporting information) beneath the current bottom-level node (i.e., the creation of a substructure that further extends the depth of the tree 35). Such additional structure consists of what are referred to herein as “support nodes” and “support links”. As discussed and illustrated herein, the support structure is the primary two-dimensional structure of the analytic tree 35.

Debate over the relative importance (or relevance) of a discussion point within a child node, in relation to the discussion point in its immediate parent node, also can lead to submission of additional points, arguments and information which can be incorporated into the structure of the analytic tree 35 using other kinds of links to other types of nodes. In preferred embodiments, support values are associated with individual nodes (indicating how much support the discussion point represented by the node has), relevance values are associated with the support links (indicating how relevant a child node is to its parent), and a strength value is a combination of these support value for the node and the relevance value to a particular parent node.

As discussed in greater detail below, a given discussion point (represented by a single node) could be designated as a child node in support of (and/or refuting) multiple different parent discussion points. In this case, the child node ordinarily will have a single support value (indicating how likely it is that its discussion point is true), but multiple different relevance values, one for each parent node to which it is linked (indicating its relative importance to the various parent-node discussion points. For example, the discussion point, “Sea levels will rise approximately 1 foot in the next 20 years” might have a certain support value (indicating how likely it is that the statement is true) and, irrespective of its support value (which should be the same in both contexts), might have a very high relevance value with respect to an issue or discussion point pertaining to city planning in New York City and a very low relevance value with respect to an issue or discussion point pertaining to city planning in Denver, Colo.

In the preferred embodiments, relevance values address how important a discussion point, if assumed to be true, would be to a specific immediate parent. Preferably, relevance values also can be conceptualized as values from 0 to 100% (or −100% to +100%, with the sign indicating the direction, typically, positive for pro and negative for con) or else can be conceptualized in a variety of different ways, such as cost/benefit impact or normalized cost/benefit (e.g., in dollars) if the discussion point were assumed to be true. However, any of the user-interface techniques for allowing users to submit their estimates of support values also can be used for allowing them to submit relevance values (e.g., clicking on a number of stars, with the same meanings discussed above, or dragging a slider bar), preferably with one difference—when a user is rating the relevance of a child discussion point that is currently in the “con” column, as discussed below, the sign of the input rating preferably is flipped before being stored as a true relevance value, because a positive “con” rating translates into a negative relevance value and vice versa.

Because of the preferred independence of support and relevance values, it is also possible to define a “strength value” as a combination (or function) of the support and relevance values. The strength value can provide an overall indication of how seriously a particular discussion point should be taken. One such function for determining strength value is to simply multiply the support and relevance values, i.e.:

$$Strength = \{ \begin{matrix}SV \cdot RV & if SV > 0 \\ 0 & otherwise ,\end{matrix}$$

where SV is the support value (individual or composite), which can have any value from −1 (meaning clearly not true) to +1 (meaning clearly true), with 0 meaning either that no evidence has been provided or that the pro and con evidence is perfectly balanced out, and RV is the relevance value (individual or composite), ranging from −1 (meaning extremely relevant as a “con” point) to +1 (meaning extremely relevant as a “pro” point), with 0 meaning that the point is completely irrelevant to its parent. In this example, the strength value has a direction (or sign) which is the same as the direction (or sign) of the relevance value. Then, if all of the child points are independent of each other, the support value for the parent might be calculated as the sum of the strength values for all of its child nodes.

On the other hand, where certain child points are related to each other, those points may be incorporated within a group and a strength value calculated for the entire group, depending upon how they are related. For instance, the strength of the group as a whole might be the maximum of the strengths of the individual nodes, the minimum of the strengths of the individual nodes, or any other function of their individual strengths. Such considerations might come into play, for example, if only one of a group of related discussion points could be true and/or where related discussion points express different degrees or amounts of the same overall concept (e.g., amount of global warming), but where the effects are nonlinear.

Strength values are important, for example, because one would want to seriously consider the prospect of a discussion point having a relatively low probability of being true if the costs associated with it actually being true are sufficiently high. Of course, other kinds of statistics also can be defined and incorporated into any of the described functions, such as those providing indications of variability in the probability of a particular discussion point being true (e.g., variants or standard deviation).

Preferably, because top-level discussion points and information related to relevance are not in direct support of any other proposition pertaining to the ultimate issue 24, the corresponding structure of the relevance analysis preferably is conceptualized separately from the main two-dimensional support structure (e.g., as illustrated in FIG. 3), but is accessible through the support link to which it pertains, as discussed above.

At some point, a true bottom node (i.e., one that cannot be reduced any further at the present time) is reached. Often, this kind of node includes a proposition that is not provable, but instead reflects one of an individual's core values and, therefore, is referred to herein as a “value node” or a “value statement”. Of course, a single point or statement can have significance both as a core value, independent of any other practical significance, and also as a point in relation to some other larger point, in which case the multiple ways in which a single proposition is significant can be represented as separate nodes or as a single node with multiple different links. For example, achieving peace between different nations can be a core value in and of itself and also can be a vehicle to enhance economic growth and/or stability. Similarly, additional argument can reveal that what was once thought to be a core value is actually a debatable point that can be challenged. For this reason, every discussion point represented by a node in the analytic tree 35 preferably is open to analysis, meaning that additional substructure can be added beneath any node in the analytic tree 35.

As indicated above, the concepts of node support values and functions for combining support values of child nodes to determine support values for parent nodes can be relevant both to the ongoing analysis or discussion process and to techniques for rating and/or ranking nodes (potentially including elimination of nodes where the rating and/or ranking is sufficiently low) at any level of the analytic tree 35. Particularly where elimination of nodes only occurs (if at all) in very clear circumstances, the accuracy of any approach to rating nodes (which preferably precedes any ranking), while helpful, ordinarily is not critical. The result of any error in such a case simply will be that one discussion point might be ranked a few positions lower or higher than it should be. Therefore, rating techniques should be good, but need not be perfect.

A variety of different systems or techniques can be used to rate the amount of support for particular discussion points. For example, voting methods can be used, e.g.: (1) allowing each general participant 14 to have an equal vote, or (2) weighting votes based upon the particular discussion point under consideration and/or the background characteristics of the general participants 14 who are voting. For example, in certain embodiments the votes of general participants 14 who have specific practical, educational and/or technical expertise that is relevant to the discussion point under consideration are given increased weight. In certain embodiments, the votes of general participants who have exhibited high-quality participation in the system 5 (either generally and/or with respect to subject matter that is related to the present discussion point) are given increased weight.

In one example, each participant 14 (which can include an administrator 12) is assigned a participation level with respect to a particular issue or discussion point. This rating preferably reflects the perceived level of objectivity for that individual and/or the individual's expertise in reference to the issue or discussion point. Preferably, any participation level assigned to a participant 14 for a particular issue takes precedence over any overall participation level for that participant 14 with respect to ratings submitted by that participant 14 on discussion points pertaining to that issue, and any participation level assigned to a participant 14 for a particular discussion point takes precedence over any issue participation level assigned to that participant 14 with respect to ratings submitted by that participant 14 on that particular discussion point or any discussion points underneath it in the analytic tree. Such distinctions might be made where, e.g., a particular person has a conflict of interest with respect to an issue or discussion point (and therefore should be assigned a lower participation level with respect to that issue or discussion point) and/or where the person has particular expertise related to an issue or discussion point (and therefore should be assigned a higher participation level with respect to that issue or discussion point). In any event, in the current embodiment the ratings submitted by the individual participants 14 are weighted by a function of the applicable participation levels assigned to them. For instance, the weight Wᵢ for the ratings submitted by a participant i might be defined as:

$${W}_{i} = \{ \begin{matrix}0 & if {L}_{i} = 0 \\ {P}^{{L}_{i} - 1} & otherwise ,\end{matrix}$$

where Lᵢ is the relevant participation level of participant i (e.g., overall, issue or discussion point, whichever is applicable and most specific) and P is a weighting base (e.g., any value from 2-10, preferably 2), and an overall rating (OR) value for a discussion point (which could be, e.g., its support value, its relevance value in relation to a specific parent point, or its strength in relation to a specific parent point) can be calculated, e.g., as the simple weighted average of the individual ratings, i.e., as follows:

$$OR = \frac{{\sum }_{i} {W}_{i} {R}_{i}}{{\sum }_{i} {W}_{i}} ,$$

where Rᵢ is the rating submitted by participant i for the discussion point (e.g., with regard to either support or relevance) or is a derived rating (e.g., strength) based on other ratings submitted by participant i for the discussion point (e.g., in this case, based on both support and relevance). In this example, the rating submitted by a participant having an assigned participation level of 4 will have P times the rate of a participant having an assigned participation level of 3 and P² times the weight of a participant having an assigned participation level of 2. Once again, any other weighting formula instead could be used. The participation levels assigned to the participants (e.g., Lᵢ) can be assigned, e.g., by the administrators 12, with or without input from the other participants 14, or can be entirely decided by the community 15 as a whole.

In any event, a voting or rating system can be used in a straightforward manner to determine the support value for a particular node, e.g.: (1) using a straight weighted mean, (2) first eliminating any outliers before computing the weighted mean, (3) computing a median (weighted or not), (4) computing a mode (weighted or not), or (5) using any other statistical technique for determining a representative value for the community 15 as a whole (either with or without techniques for reducing the impact of potentially biased and/or low-quality participants).

Choosing an appropriate function for combining the support values of child nodes to calculate the support value for a parent node preferably is done in a somewhat different manner. For instance, relevance values for the links between the child nodes and the parent nodes (e.g., determined in any of the ways discussed above) can be used in a straightforward manner to weight the support values for the corresponding child nodes. For example, one could calculate the support value of a parent node as:

$$DSVP = {\sum }_{j} {SV}_{j}^{′} \cdot {RV}_{j} ,$$

where DSVP is the derived support value of the parent node, SV′ⱼ is the adjusted support value for child node j, and RVⱼ is the relevance value for child node j. In this example, RVⱼ can take on positive values (indicating degree of relevance with respect to a “pro” position) or negative values (indicating degree of relevance with respect to a “con” position). Also in this example, SVⱼ, the support value for child node j, can take on positive or negative values (for the reasons discussed above). Therefore, it is preferable that

$${SV}_{j}^{′} = \{ \begin{matrix}0 & if SV < 0 \\ {SV}_{j} & otherwise .\end{matrix}$$

On the other hand, if SVⱼ is restricted to positive values only, then preferably SV′ⱼ=SVⱼ.

As will be readily appreciated, a parent node often can have both a DSVP (based on the support and relevance values for its child nodes) and an OR for its support value (based on direct support-value ratings submitted by participants in the community for the node). Either of these values can be used as the final support value for the node. Alternatively, any desired combination of them (e.g., a weighted average) can be used as the final support value for the node. In any event, any function for combining these two support values into a final value typically will involve (either explicitly or implicitly) some kind of weighting of the two values. This weighting can be accomplished using fixed predetermined weights or weights that vary based on any selected factors. For example, it might be desirable to weight the DSVP value more heavily if there is more activity (e.g., rating submissions) with respect to the current node's child nodes than there is with respect to the current node itself, and to weight the OR value more heavily if there is more activity with respect to the current node than there is with respect to the current node's child nodes.

In certain embodiments, one or more of the administrators 12 identifies a function for calculating a derived support value for each of one or more nodes (e.g., based on the support values and the relevance values of its child nodes), and this function preferably can then be challenged by the community 15 (e.g., with individual general participants 14 proposing changes to it). In still further embodiments, a set of potentially valid functions first is identified, e.g., by requiring a minimum level of support for each function in the set (e.g., with different weights applied to ratings from different participants 14 using any of the techniques discussed above), and then a weighted vote is conducted among the competing functions. The results of this vote can be used in a variety of different ways. For example, it is possible to use only the most popular function (e.g., the highest number of weighted votes). In alternate embodiments, however, all of the functions are applied (potentially with the exception of any functions that received less than a specified amount of the weighted vote), and then their results are combined using weights that are equivalent to the respective percentages of the votes that such functions received.

It is noted that the foregoing discussions regarding the calculation of the support value of a parent node based on the support and relevance values for its child nodes can be applied irrespective of whether the child-node values are composite values (e.g., based on ratings from the entire community or some portion of it), individual values (e.g., submitted by a single participant 14), or combinations of the two (e.g., some being aggregate values and some being submitted by just the individual participant 14 for whom the parent node value is being calculated).

Still further, any ratings system that is employed can produce generic results, i.e., values that are used in connection with (e.g., provided to and/or used for ranking the discussion points presented to) anyone who subsequently reviews the analytic tree structure 35. Alternatively, a rating system can produce results that are customized to the individual user, such as by collecting information regarding the individual and/or querying the individual regarding his or her core values, and then generating results based solely or primarily on, or at least slanted toward, the ratings submitted by those general participants 14 who have similar attributes (e.g., personal or demographic) and/or similar core values (e.g., as indicated based on their votes with respect to the support values for the core value nodes and/or the functions for combining support values for child nodes that include at least one such core value node to determine the support value for a parent node).

In addition to the foregoing ratings values, a variety of other kinds of metrics can be calculated and displayed by server 10. For example, it often will be desirable to have activity metrics, indicating the amount of activity that has occurred with respect to individual nodes. Such metrics can indicate whether a particular discussion point has been heavily analyzed (usually meaning that the most relevant points pertaining to it probably have already been identified) or whether it has been analyzed very little (potentially meaning that some important points pertaining to it have not yet been identified and, therefore, that ratings submitted by the participants 14 might not be very reliable). Activity metrics can be calculated for an individual node as a function (e.g., a weighted summation) of, e.g.: the number of informal comments submitted (for that node and/or for all the nodes beneath it in the analytic structure 35), the number of nodes beneath it in the analytic structure 35, the number of ratings received (for that node and/or for all the nodes beneath it in the analytic structure 35), the amount of time that the node has been active, and/or the number of users (or different users) who have viewed that discussion point and/or its child points, where the number of users for any or all of the foregoing purposes can be simply counted or can be weighted based on their assigned participation levels (e.g., in the same manner that their ratings are).

The evolution and expansion of the analytic structures 35 over time often will mean that ratings submitted at one point in time might no longer be useful at a later point in time (e.g., because new discussion points have been added that were not considered when those earlier readings were submitted). However, it frequently will be the case that all participants 14 will not go back and revise their ratings each time it would be advisable to do so. To address this problem, e.g., recent ratings can be weighted more heavily than earlier readings (e.g., using an exponentially declining weight based on age), ratings older than a predetermined age can be simply disregarded or canceled, an administrator 12 can have the ability to specify a cutoff date (e.g., for individual nodes) prior to which any ratings for the specified node (and potentially for some or all nodes above it in the hierarchical structure 35) would be disregarded or canceled, such a cutoff date can be specified automatically based on any predetermined increase in a calculated activity metric, and/or any combination of these approaches and/or others can be used.

### Exemplary User Interfaces.

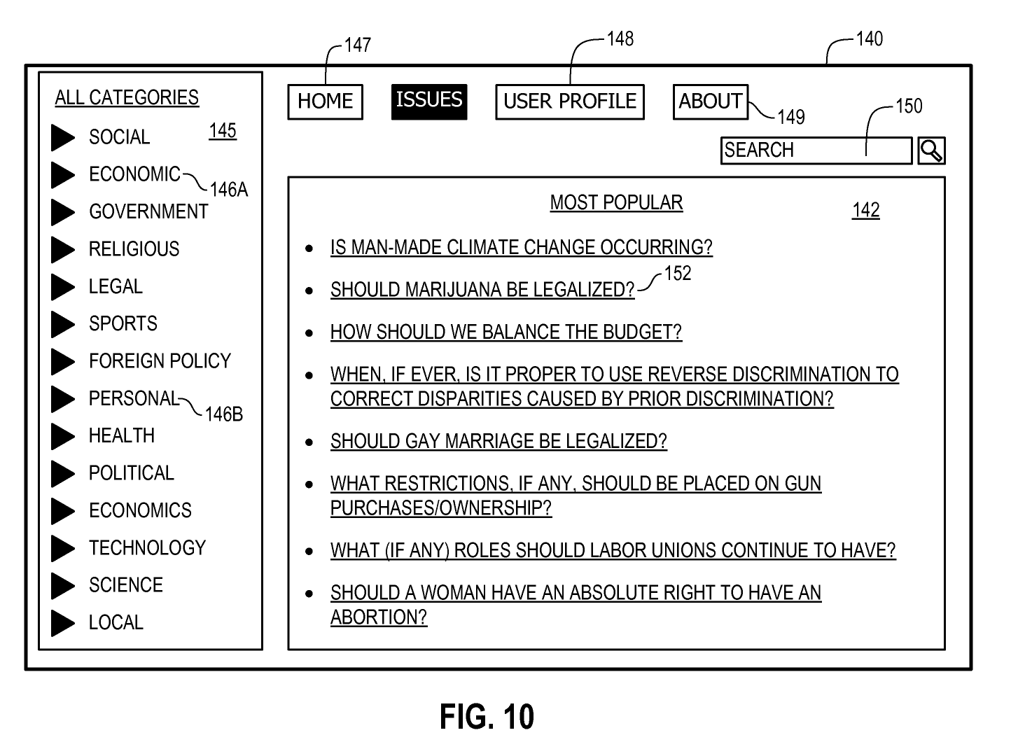

The following discussion concerns exemplary user interfaces for an implementation of system 5 according to one representative embodiment. Initially, FIG. 10 illustrates an exemplary main issue page 140 that lists a variety of different issues 142 that are available to be simply viewed or actively analyzed by different individuals (e.g., anyone in the general public). In the preferred embodiments, the list 142 shows the most popular or currently trending issues. Although only a single such list is shown, multiple different lists instead can be provided. In any event, each issue preferably functions as a link to some aspect of the analytic structure associated with it, as discussed in greater detail below.

Also included on main issue page 140 is a listing 145 of various categories of issues. Each category (e.g., category 146A for economic issues) preferably functions as a link to a page that displays the issues included within it and/or to any subcategories underneath it. As to the latter, for example, clicking on the “Personal” category 146B link might result in the display of a page that includes links to subcategories for “Family”, “Exercise and Diet” and “Personal Finance” issues, as well as links to individual issues (e.g., all or the most popular issues within the “Personal” category, or only those issues that do not pertain to any particular subcategory). In the preferred embodiments, a given issue or subcategory can be listed under more than one category and/or subcategory. For instance, the “Personal Finance” subcategory could be included under both the Economic issues category 146A and the “Personal” category 146B.

Finally, page 140 can include links to other portions of the site, such as a link 147 to a home page, a link 148 to a page for the current user's profile (e.g., for selecting default settings pertaining to the use of the site), and a link 149 to a page describing the site. Preferably, page 140 also includes a search field 150 for searching for particular terms or keywords across all issues that are analyzed on the site.

In the preferred embodiments, a user enters the site as just a consumer (or browser) of the information (rather than an active contributor), unless the user specifies otherwise in his or her user profile. In this regard, information preferably is presented somewhat differently depending upon the user's status as a browser or contributor, as discussed in greater detail below.

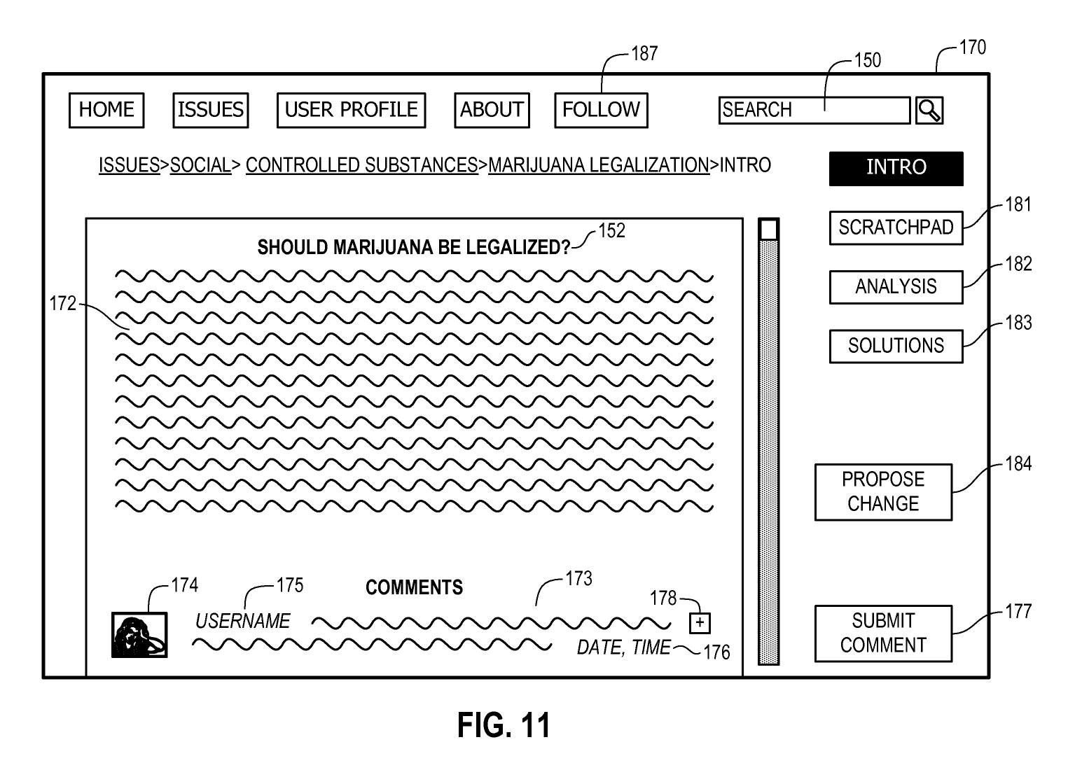

After navigating through the various issue pages (potentially including various category and/or subcategory pages), the user eventually clicks on an issue (e.g., issue 152) that he or she wants to explore. FIG. 11 illustrates an exemplary page 170 that might be displayed upon clicking on a link for a specific issue. Included within page 170 is a statement 152 of the issue, a textual introduction 172 (preferably in essay or blog format, explaining the issue and any additional or preliminary thoughts the author has pertaining to it), and a comments section 173 where users can post informal comments pertaining to the issue.

Preferably, the comments in section 173 generally are arranged in reverse chronological order. However, users preferably have the ability to comment on other users' comments (or submit a comment in response to another comment), e.g., by clicking on user interface element 178. More preferably, all such response comments are placed underneath the comments to which they pertain, but indented somewhat to the right or using any other technique to visually indicate the comments to which they refer, and all response comments pertaining to the same original comment preferably are arranged in reverse chronological order underneath the comment to which they pertain. Each comment preferably is accompanied by a photograph, avatar or other graphic 174 representing the user who submitted the comment, a username 175 for the user who submitted the comment, any other information identifying the individual who submitted the comment, and/or a date/time stamp 176 indicating when the comment was submitted. Clicking on link 177 takes the user to a page for submitting a new comment (e.g., not necessarily related to, or a direct comment on, any existing comment) to be included within the comments section 173.

As indicated below, each issue and discussion point preferably has an associated comments section (e.g., similar to section 173). This informal portion of the analysis can be very important in helping the community 15 to sort through a variety of different submitted ideas before organizing them into the more formal structure 35. That is, in many cases the discussion points that ultimately become nodes within structure 35 will begin and then evolve through a series of informal comments contributed by various members of the community 15.

In addition, in the present embodiment page 170 includes links 181-183 to other pages (discussed below) pertaining to the issue 152. Generally speaking, clicking on scratchpad link 181 causes a page to be displayed that shows a list of the top-level discussion points with a somewhat different format and than the analysis pages, clicking on analysis link 182 causes the top-level analysis page to be displayed and clicking on solutions link 183 causes a page to be displayed for proposing, commenting on and analyzing potential solutions based on the analysis that has been performed (e.g., solutions that attempt to obtain the maximum benefits identified during the analysis while incorporating strategies that mitigate the drawbacks identified during the analysis).

Still further, page 170 includes a link 184 to a page for submitting a proposed change to the textual introduction of 172. Such changes can become desirable after the issue has been flushed out through the formal and informal analyses discussed herein.

Page 170 also includes a link 187 that a user can click on to “follow” the issue (e.g., meaning that certain or all changes regarding the issue, such as postings of proposed new or modified discussion points, automatically trigger e-mail or other electronic messages to be sent to the user, notifying the user of such changes). A similar “follow” button preferably exists for each node (issuer discussion point) within the analytic structure. In certain embodiments the user can tailor the follow functionality (e.g., by default and/or in each specific instance that it is invoked) so as to receive such notifications, e.g., regarding any such changes pertaining to the issue, regarding only the current node and its immediate child nodes, or regarding only the current node and anything beneath it.

Although the search box 150 also is provided on page 170, once an individual issue has been selected (i.e., when the user is on a page pertaining to a specific issue, as is the case, e.g., for FIGS. 11-20), searching preferably is limited by default to just information pertaining to that issue, while in the more general pages (such as page 140), searching by default preferably is across all issues; however, the user preferably has the ability to change these defaults, if desired (e.g., on a global basis and/or on a case-by-case basis).

It is noted that a different initial page can be displayed when a user first clicks on an issue, and the initial page that is displayed can be the same across all users, can be user-customizable and/or can be contextual (e.g., depending upon whether the user already has viewed that particular issue and/or whether the issue is relatively new or has undergone a significant amount of analysis/discussion). Other possibilities for the initial page include any of the pages discussed below, such as any of the pages that are displayed upon clicking on any of links 181-183. Also, the initial issue page can include any combination of aspects from these different pages. For example, in certain embodiments, the elements displayed on page 170 and the elements displayed on the page accessed from link 181 instead are all displayed on a single page, which could be the initial page for the issue.

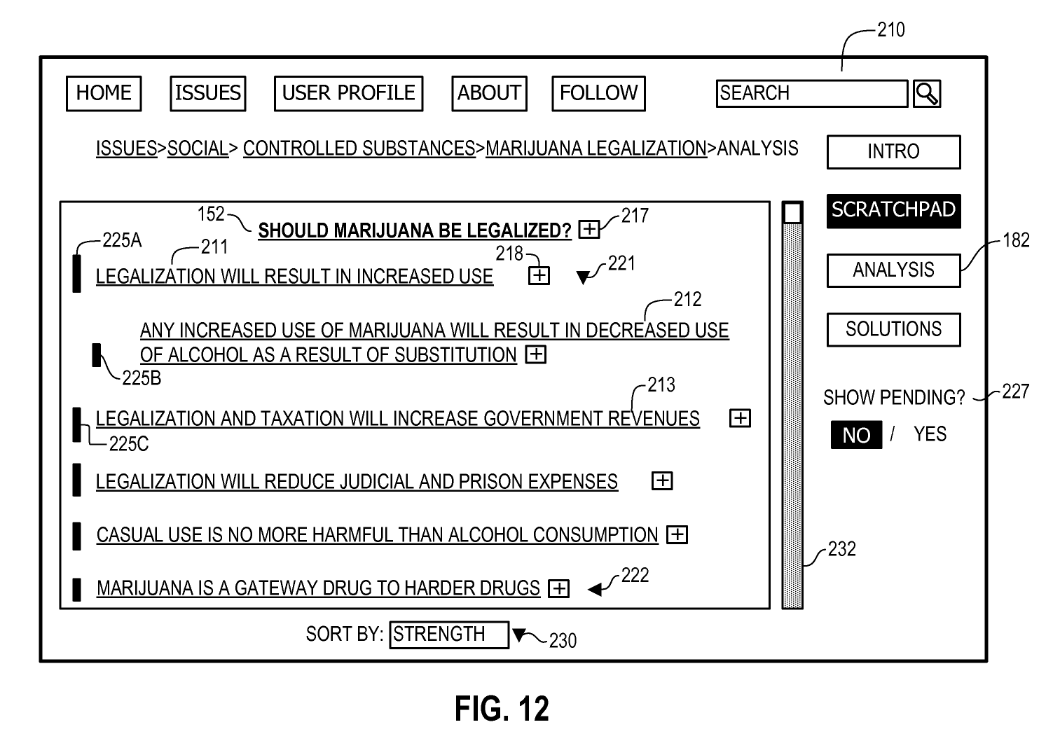

The scratchpad page 210, reached from link 181 and shown in FIG. 12, preferably displays the issue (i.e., the top node in the structure 35) and all the top-level discussion points (i.e., those immediately beneath the top issue node, which on this page 210 can include both active and pending discussion points), such as discussion points 211-213, that have been submitted by the community 15 pertaining to the issue 152 under consideration. When used, scratchpad page 210 preferably functions as a starting point for analyzing the issue 152, allowing users to submit potentially relevant discussion points without having to consider whether or not those discussion points support or refute the issue 152, in other words, to function as a kind of brainstorming area. In fact, when an issue initially is being analyzed, it often will not even be clear whether a particular discussion point ultimately will support or refute a given position.

From page 210, an icon 217 can be clicked to reach a page for adding another top-level discussion point. In addition, each discussion point (e.g., discussion point 211) preferably has an associated icon (e.g., icon 218) that can be clicked to add a sub-point (e.g., discussion point 212) underneath it. For purposes of this scratchpad page 210, each such lower-level discussion point preferably pertains to something that follows directly from its parent (e.g., its truth depends at least to some extent on its parent statement also being true). This relationship is different than the relationship of lower-level to higher-level discussion points in most or all of their pages pertaining to an issue, where the discussion point in lower-level nodes ordinarily supports or refutes the truth of the discussion point in their immediate parent nodes. Icons 221 and 222 preferably are provided for discussion points that also have sub-points underneath them, and clicking on them preferably acts as a toggle switch to expand (and therefore show) the sub-points (e.g., as illustrated by icon 221) or to collapse (and therefore hide) the sub-points (e.g., as illustrated by icon 222).

The top-level discussion points and/or the sub-points can be arranged arbitrarily or, at each level, the discussion points can be sorted based on any (e.g., user-selected) criterion. In the present example, the discussion points at each level are sorted based on strength, which preferably is calculated based on a combination of the support value, indicating the level of support for the corresponding discussion point (or an evaluation of the likelihood that the statement is true), and the relevance value, indicating how relevant the discussion point is to the overall issue. In the present embodiment, the heights of the strength bars (e.g., bars 225A-C next to discussion points 211-213, respectively) provide a visual indication of the current strength values for the corresponding discussion points.

In the preferred embodiments, the user has a choice as to how to order the discussion points displayed on page 210, e.g., by clicking on the drop-down menu icon 230 and selecting the desired sorting criterion. As noted above, in the specific example illustrated in FIG. 12, the discussion points are sorted based on strength. However, the user might instead choose to sort based on activity (e.g., the total amount of comments, discussion points and edits contributed over the preceding specified number of days), based on relevance values alone, or based on support values alone. In certain embodiments, when the sorting criterion is changed in this manner the bars (or other visual indicia) that indicate strength in the present example are set to visually display the level of the parameter corresponding to the sorting criterion, thereby allowing the users to quickly identify the discussion points that have at least a threshold level with respect to that sorting criterion. Also, it should be noted that only a portion of the complete set of discussion points is visible at any given time within page 210; a scrollbar 232 permits the user to scroll through and review all of the discussion points.

A radio button 227 allows the user to select whether only currently active discussion points are to be displayed (as is the case in the example illustrated in FIG. 12) or whether the “pending” discussion points also (or instead, depending on the embodiment) are to be displayed. As discussed in greater detail below, in the preferred embodiments, discussion points initially are pending until they are adequately refined or otherwise accepted to become part of the analytic tree structure (i.e., active nodes in the structure).

In any event, clicking on one of the displayed discussion points preferably causes a discussion-point page to be displayed on which users can submit informal comments, similar to comments section 173, related to the discussion point. Also, or instead, in certain embodiments the discussion-point page also permits users to analyze the merits of the discussion point, e.g., using the two-column drill-down technique described below, potentially including any or all of the functionality described below in connection with such analysis pages. Alternatively, separate informal comment and formal analysis pages can be provided.

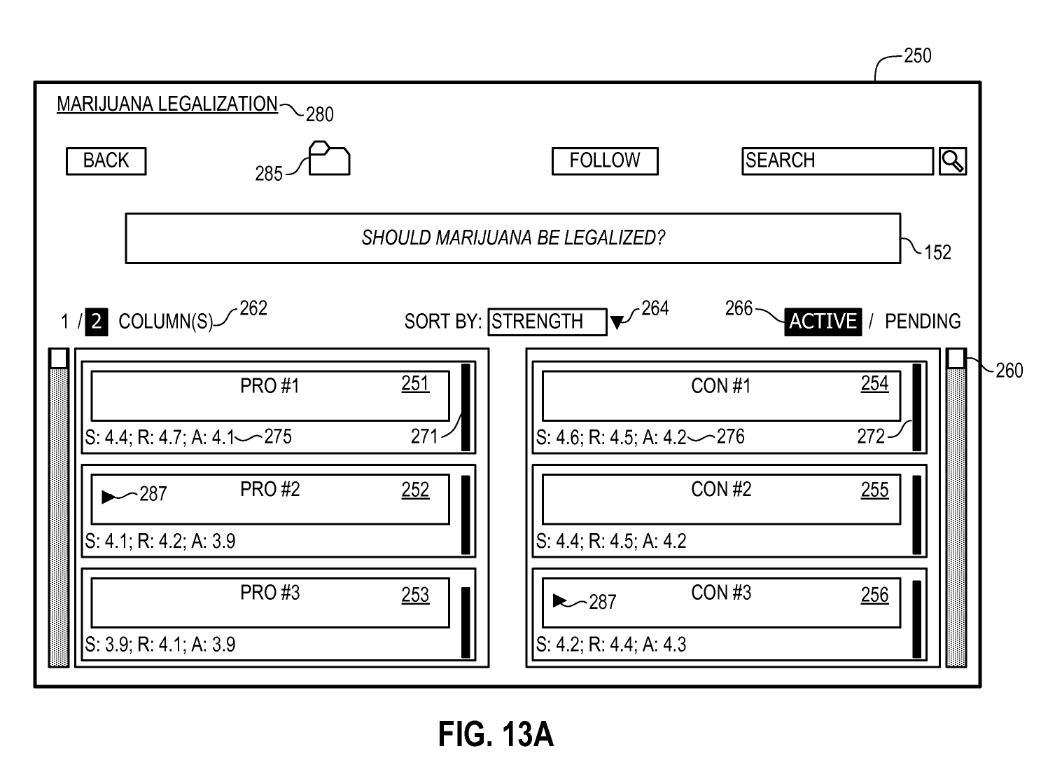

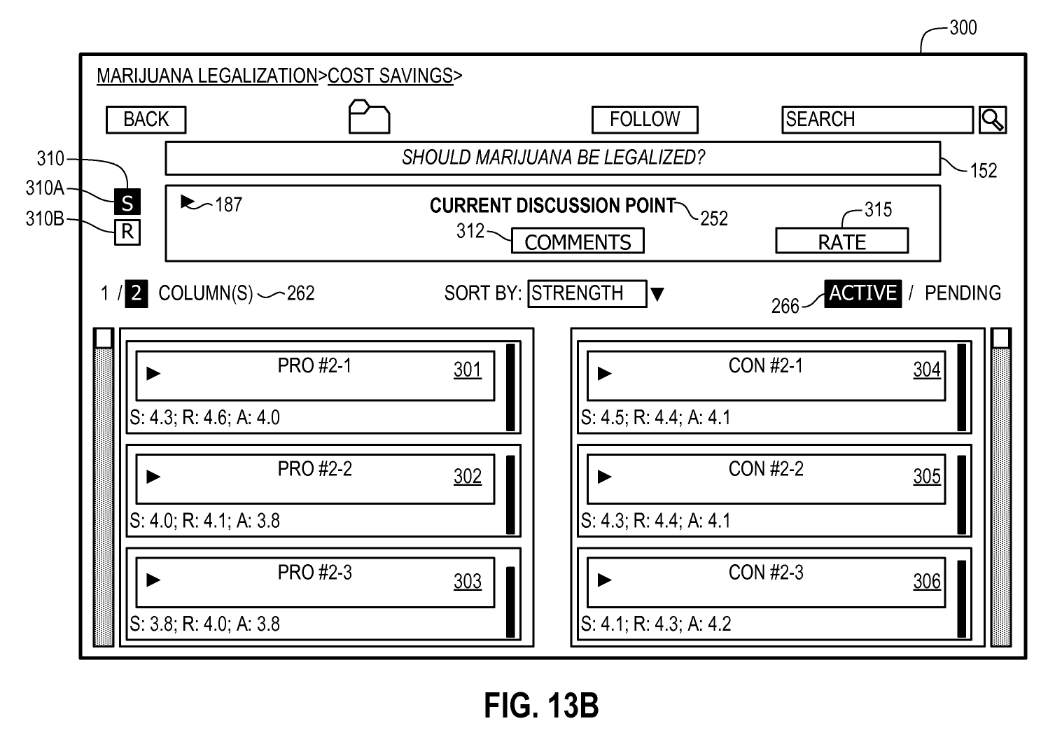

In the present embodiment, clicking on the analysis link 182 or the issue link 152 preferably causes the top-level analysis page 250 (shown in FIG. 13A) to be displayed. In certain embodiments, the scratchpad page 210 is omitted and top-level analysis page 250 is the second page a user normally would encounter in connection with a selected issue (after the introduction page 170).

Top-level analysis page 250 includes the issue statement 152 (which is included within the top node 24 in the underlying analytic structure 35). Underneath the issue statement 152 are all of the top-level discussion points (e.g., included within top-level nodes 41-45 nodes in the analytic structure 35). In the present example, only six discussion points (251-256) are visible, but additional ones can be viewed by clicking and dragging scrollbar 260. Generally speaking, the statement of any discussion point set forth in any of the user interfaces described herein preferably also includes the descriptions of any corresponding assumptions and/or action dependencies pertaining to that discussion point. Each such assumption and/or action dependency preferably is provided as a distinct item which serves as a link to a page for such assumption or action dependency (e.g., where informal comments can be made and/or where child discussion points can be proposed for analyzing whether the assumption is relevant and/or supported). Also, on page 250 radio button 262 allows the user to choose whether to display the discussion point in a single-column format or in a two-column format, with the two-column format having been selected in the present example, so that all of the pro discussion points (e.g., points 251-253), in this example the points supporting the legalization of marijuana, are on the left side, and all the con discussion points (e.g., points 254-256), in this example the points against the legalization of marijuana, are on the right side. In addition, from the drop-down menu 264, the user has selected to have the discussion points sorted based on strength. Alternatively, the user might have had the ability to have them sorted, e.g., based on their support values, their relevance values, or the amount of activity pertaining to them, by simply selecting the desired option from the drop-down menu 264. Because the user has selected the two-column format, the pro-discussion points are sorted separately than the con discussion points, so that the best points on each side of the issue are visible side-by-side.

In this regard, in the present example page 250 displays, for each discussion point, a strength bar (e.g., bars 271 and 272 for discussion points 251 and 254, respectively), the height of which corresponds to the strength value (e.g., as discussed above) that has been calculated for the discussion point. In addition, page 250 displays for each discussion point a set of other values associated with the discussion point (e.g., sets 275 and 276 for discussion points 251 and 254, respectively), including, e.g., a support value (e.g., indicating the extent to which the corresponding lower-level discussion point is supported), a relevance value (e.g., indicating how relevant the corresponding discussion point is to the issue 152) and an activity value (e.g., indicating how much formal analysis and/or informal commenting has taken place with respect to the corresponding discussion point), designated by the letters S, R and A, respectively, in FIG. 13A. In this way, the user can quickly and easily see all of the most important summary information pertaining to all of the discussion points immediately beneath issue 152, thereby quickly getting up to speed regarding issue 152. Although not shown in FIG. 13A, the displayed sets of values also can include the strength value. Also, the bars (e.g., 271 and 272) can have the same meaning irrespective of the sorting criterion specified with drop-down menu 264 or can be changed to reflect the value of the sorting criterion, as desired. Still further, additional bars or other visual indicia can be provided to indicate any of the values associated with a discussion point, either in addition to or instead of the display of their numerical values.

Some or all of the discussion points also have additional explanation. In this regard, it sometimes is the case that in order to keep the discussion point as brief as possible (which ordinarily is desired), certain terminology and/or concepts might be included within them. At the same time, it is highly desirable to make each discussion point understandable to as wide an audience as possible. Therefore, as discussed in greater detail below, when creating a discussion point a user is permitted to provide additional explanation. Thus, for example, discussion points 252 and 256 have an associated expansion icon 287. When in the illustrated position, clicking on expansion icon 287 causes this additional explanation to be displayed. Then, clicking the icon 287 again collapses the explanation so that it is no longer visible. In this way, if the user understands a discussion point without further explanation, nothing need be done. However, if anything in it is unclear, the user can click on its icon 287 to obtain further explanation.

Also included on page 250 are radio buttons 266 allowing the user to select whether only active discussion points are to be displayed or whether pending discussion points are to be displayed in addition (or instead). In the preferred embodiments, if the “pending” setting has been selected, the pending discussion points are displayed in addition to the active ones, e.g., with the pending discussion points at the top of the list. However, in certain embodiments the user has the option to select whether the pending discussion points are displayed with the active ones or separately.

Navigation map 280 shows the user the context in which the current page is being displayed in relation to the overall analytic structure 35. In the present case, page 250 is the main issue page, so navigation map 281 displays just the title of the current issue. As the user goes deeper into the analytic structure 35, navigation map 280 becomes more important for helping the user to understand where he or she is in analyzing the issue.

One of the powerful features of a system according to the preferred embodiments of the present invention is the ability to make connections across different analyses, e.g., to reference the same discussion point in different contexts. Doing so not only prevents replication of effort in analyzing the amount of support that is present for the subject discussion point, but also brings consistency to the various analyses, e.g., making it more difficult for individual users to take different positions in different situations. In the present embodiment, this feature is implemented through the use of a folder 285 into which the user can store discussion points or other statements and/or assertions (e.g., any node) within any of the various analytic structures (e.g., including assumptions or action dependencies, as well as other kinds of nodes). More specifically, the user preferably has the ability to drag the desired discussion point (which preferably includes its related assumption and/or action dependency nodes) or other node into folder 285, click on a provided “save” button, or perform any other action in order to cause a reference to it to be stored into folder 285. As discussed in greater detail below, these saved nodes (or links to them) preferably can then be inserted where desired, effectively causing a link to be created to the same item in another location.

Optionally, although not shown in the drawings, the user preferably also has the ability to select whether to display composite ratings (e.g., aggregated across all participants 14 or any designated subset of the participants 14) or to display only (or primarily) the user's own ratings. Whichever is selected, the discussion points preferably also are ranked based on the selected ratings. More preferably, the user has the ability to select which ratings to use as a default matter (e.g., across all issues, typically selected in the user's profile section) and/or to select which ratings to use for any particular issue (e.g., by including a selection radio button on page 250 and/or on any or all of the other issue-specific pages. If the user has selected display of (and ranking based on) the user's own ratings, then in any instance where the user has not in fact submitted a particular rating value, the corresponding composite rating value automatically is used, together with a designation (e.g.,*) that it is a composite rating and not the user's own rating value. In this way, comprehensive rating information can be displayed and ranking can be performed across all discussion points, while still allowing the user to quickly and easily identify any values for which a rating has not been submitted.

Each of the discussion points displayed on page 250 (e.g., discussion points 251-256) preferably functions as a link. In the present embodiment, clicking on a discussion point effectively causes one to drill down (or zoom in) one level into the analytic structure 35 and, more specifically, causes a new page pertaining to the selected discussion point to be displayed. For instance, in the current example clicking on discussion point 252 causes a page 300 to be displayed, as shown in FIG. 13B.

As indicated above, once the analytic structure 35 has been fairly well developed, it can be easy to obtain a quick overview of the most important points pertaining to the issue 152 simply by viewing page 250. The display of numeric values and/or visual indicia indicating the various metrics discussed herein also can help the user to obtain a quick sense of how strong each point is. However, in certain circumstances a user might not understand why a particular point has been rated, e.g., as highly relevant or as not very well supported. In those cases, the user preferably can click on that discussion point, thereby drilling down (or zooming-in) on it to discover more information about it.

Preferably, page 300 is very similar to page 250. However, rather than the focus being the main issue 152 (which is the case on page 250), the focus of page 300 is discussion point 252 (which is now the “current” discussion point). Thus, all of the discussion points listed underneath discussion point 252 (e.g., points 301-306) pertain only to discussion point 252, not the overall issue 152. One feature of page 300 is the pair of radio buttons 310, which include a support button 310A and a relevance button 310B. In the present example, support button 310A has been selected (so that the entire page 300 is support-focused) and the user has again selected (e.g., either directly or by default) a two-column display. As a result of these selections, each of the discussion points in the left column (e.g., each of points 301-303) supports the validity of discussion point 252 (e.g., tends to show that it is true) and each of the discussion points in the right column (e.g., each of points 304-306) refutes the validity of discussion point 252 (e.g., tends to show that it is not true), and rating button 315 would be used for rating the level of support for discussion point 252.

If, on the other hand, the user had selected relevance button 310B, then page 300 would have been relevance-focused, e.g., the left side would display the points tending to show that the current discussion point 252 is relevant to the main issue 152 and the right side would display the points tending to show that the current discussion point 252 is not relevant to the main issue 152. Also, rating button 315 would be used for rating how relevant discussion point 252 is to the main issue 152.

Clicking comments link 312 on page 300 preferably causes a page that includes a list of informal comments pertaining to the current discussion point 252 (e.g., similar to comments section 173 described above) to be displayed. Alternatively, the informal comments pertaining to the current discussion point 252 can be displayed directly on page 300, i.e., the same page as its formal analysis (which includes its child-note discussion points, such as points 301-306). In such a case, each of the two sections (formal analysis and informal comments) preferably can be collapsed or expanded by the user, thereby allowing the user to focus on either desired section, and to switch back and forth between the two, without undue clutter from the other section.

It is noted that in the preferred embodiments of the invention, each node in the analytic structure 35 is provided with a comments section as well as user interface elements for allowing users to submit proposed child-node discussion points (which preferably become pending discussion points in the first instance). In this way, users can contribute to the overall analysis in different ways, thereby increasing everyone's potential contributions. In this regard, some users will be more comfortable just submitting informal comments. Others will have a greater ability and desire to synthesize both their own thoughts and ideas provided by others through the informal comments section into formal discussion points that can be proposed for inclusion into the formal analysis structure 35.

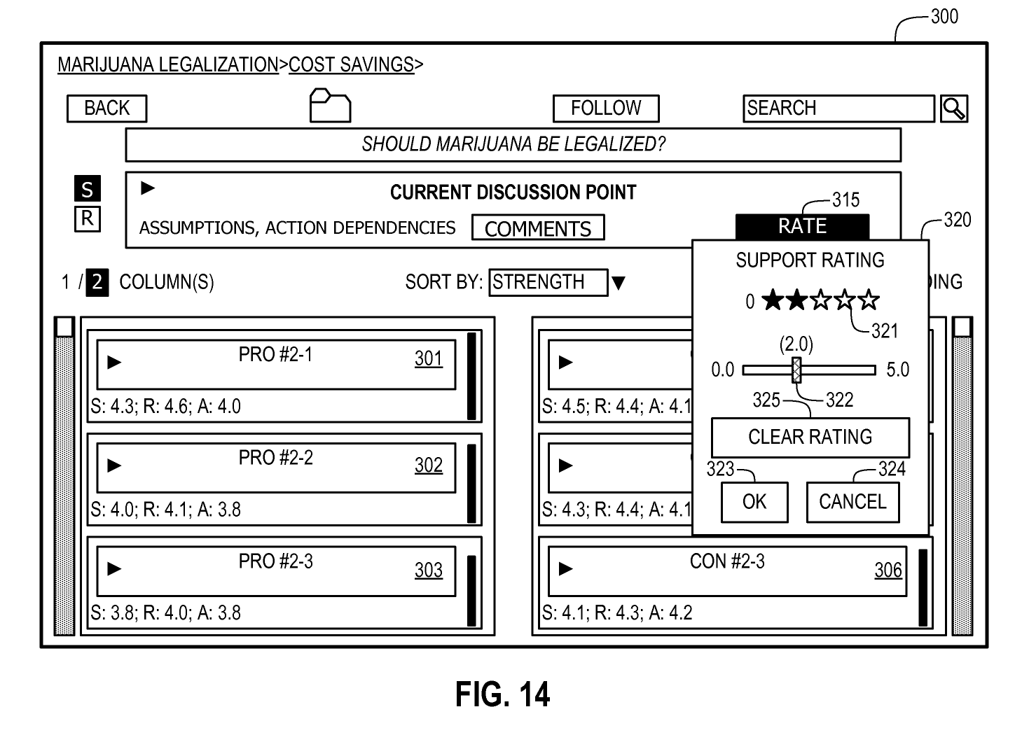

Also included on page 300 is a button 315 which the user can click to rate the current discussion point 252. In the preferred embodiment, clicking button 315 causes a pop-up rating box to be displayed, e.g., rating box 320 shown in FIG. 14. Using rating box 320, a user can submit a rating pertaining to the current discussion point 252. In the present example, radio button 310A has been selected, so the user is in the “support view”, meaning that the displayed information pertains to support for the current discussion point 252. As a result, all of the discussion points (e.g., 301-306) support or refute the validity of the current discussion point 252, and the rating that is submitted through box 320 is the user-assigned support value for the current discussion point 252. Because of the format in which the child discussion points (e.g., points 301-306), as well as the related information pertaining to them, are displayed, it is a straightforward and relatively easy matter for the user to review those child discussion points, determine how well supported the current discussion point 252 is, and then submit an appropriate rating based on this evaluation.

In the present example, the user is given the ability to create the current discussion point 252 on a scale of 0-5, e.g., with a zero rating reflecting a judgment that either that there is no significant evidence that the discussion point is true or that the evidence that the discussion point is true is approximately balanced out by evidence suggesting it is not true, and with a rating of 5 reflecting a judgment that the discussion point certainly, or almost certainly, is true. However, in alternate embodiments any other rating scale can be used, such as rating scales that also include negative values, e.g., with a negative rating reflecting a judgment that the balance of the evidence suggests that the discussion point is not true. In one particular preferred embodiment, the rating scale is from −5 to +5, with 0 and +5 having the meanings indicated above and with −5 reflecting a judgment that the discussion point certainly, or almost certainly, is not true.

Any of a variety of different user interface elements may be used for entering the rating information into box 320. In the present example, the user may click on 0 or a desired number of stars using interface element 321 in order to enter an integer rating value or may drag slider 322 in order to enter a more precise value (e.g., where changing the value on one of element 321 or 322 also causes the other's value to change). However, any other user interface element also (or instead) may be used, such as a field for directly entering a numeric value. In any event, once a value has been entered, the user clicks on button 323 to submit it or button 324 to cancel it and close box 320. In the event that the user previously has entered a rating, the value of that rating (e.g., represented as a corresponding number of stars) preferably appears in place of the “Rate” button 315, but still functions as a link to cause rating box 320 two pop up. Upon clicking on the link, the user can either change his or her previous rating or click on button 325 to clear the previously submitted rating (which might be desirable, e.g., if new discussion points have been submitted that cause the user to become undecided about how the current discussion point 252 should be rated).

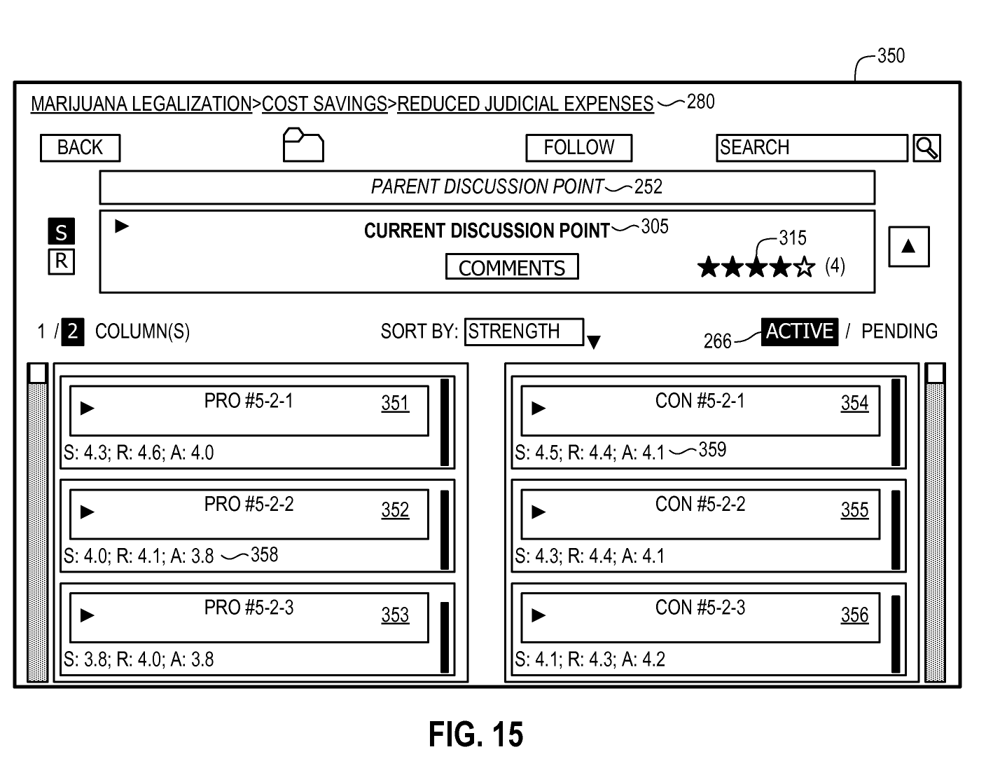

Briefly returning to FIG. 13B, from page 300 users preferably have multiple different ways of navigating through the analytic structure 35. For instance, issue statement 152 preferably functions as a link which, if clicked, takes the user to page 250 (thus allowing the user to move up a level in analytic structure 35). In addition, the user preferably can click on any of the child-note discussion points (e.g., any of points 301-306) in order to move a level down in analytic structure 35. For instance, in the present example clicking on discussion point 305 preferably causes page 350 (shown in FIG. 15) to be displayed.

Page 350 is similar to page 300. However, on page 350 the current discussion point is now discussion point 305, and instead of issue 152 being displayed above it, discussion point 252 is. Generally speaking, each user interface (e.g., page) pertaining to the analytic structure 35 preferably focuses on one of the nodes, e.g., a discussion point (typically referred to as the current discussion point) or the overall issue, as applicable, and preferably also displays the node (overall issue or discussion point), if any, that is the current node's immediate parent (e.g., particularly for reference in analyzing the relevance of the current discussion point to its immediate parent). Clicking on this parent statement causes the user to move up one level in the analytic structure 35, while clicking on of the displayed child discussion points (i.e., any child of the current statement) causes the user to move down one level in the analytic structure 35.

In the current example of page 350, the rating interface element 315 shows the current rating for the current discussion point 305. As noted above, certain ratings are included within the sets of values (e.g., sets 358 and 359) associated with the child discussion points. Preferably, even where those values indicate composite ratings for the corresponding discussion points (e.g., if the user has elected to have composite ratings shown), the rating interface element 315 shows the user's own rating (if any) of the current discussion point (4 of a possible 5 in the current example), or no rating if the user has not yet rated it. The reason for this preference is so that the user will not be biased when rating the current discussion point, but instead will be more likely to objectively review the child discussion points (e.g., points 351-356) and then independently arrive at a rating for the current discussion point (e.g., discussion point 305 on page 350).

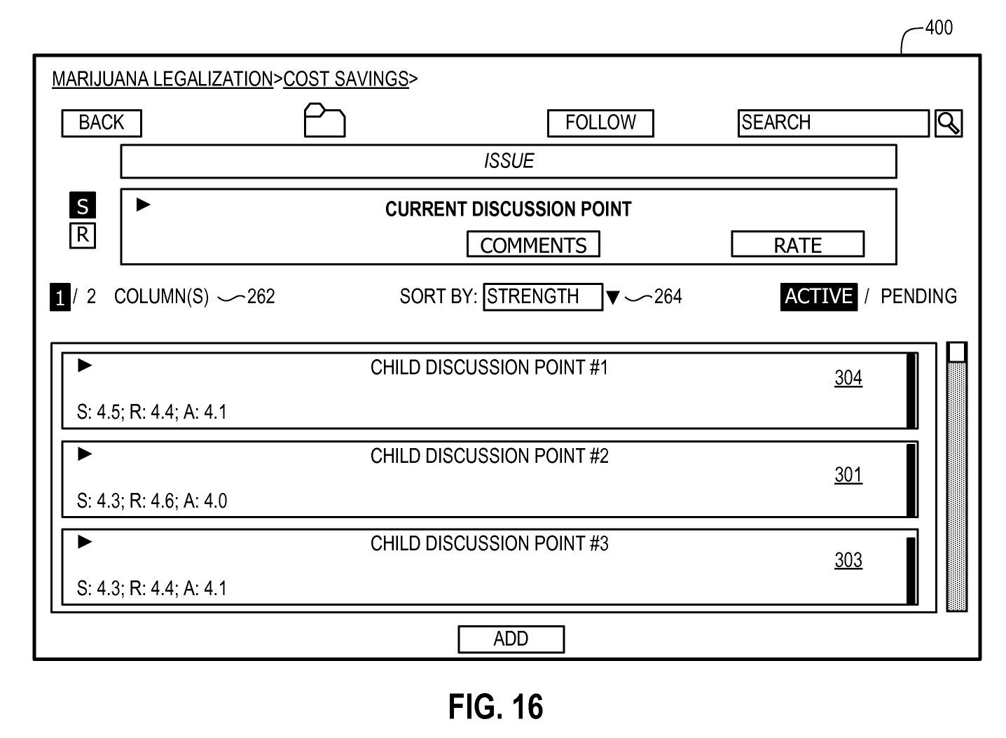

FIG. 16 illustrates a page 400 that might be displayed if the user were to select the single-column option from user interface element 262 on page 300. Generally speaking, page 400 is identical to page 300 except that the child discussion points (e.g., points 304, 301 and 303) are no longer separated into separate pro and con listings, but rather are displayed in a single list, in this particular example sorted according to strength, as selected by the user from drop-down menu 264. That is, the strongest points (as rated by the user or based on composite ratings, e.g., depending upon the option selected by the user) are presented first, irrespective of whether they are pro or con discussion points. It is noted that in embodiments where the scratchpad page 210 is omitted, a page similar or identical to page 400 can be used in its place and can serve a very similar purpose to that described above for page 210.

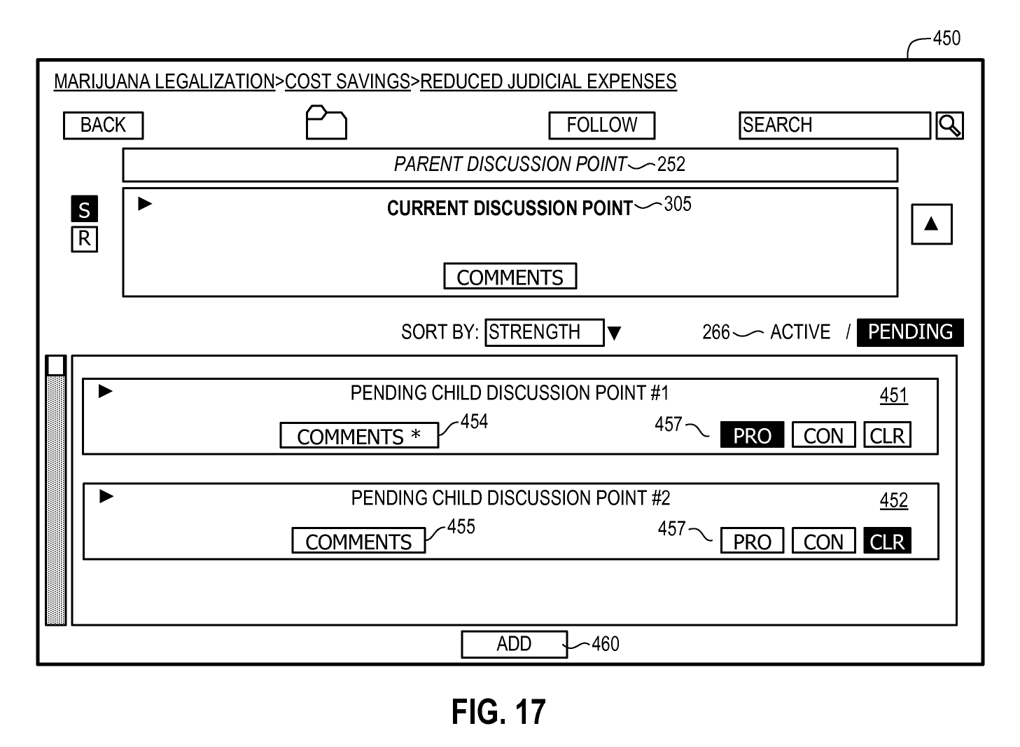

FIG. 17 illustrates a page 450 that might be displayed if the user were to select the Pending discussion points from radio buttons 266 on page 350 (shown in FIG. 15). Generally speaking, page 450 is similar to a combination of pages 350 and 400, but displays the currently pending discussion points (e.g., points 451 and 452) rather than the active ones. As indicated above, pending discussion points are those that have been proposed (e.g., by one of the participants 14) for inclusion within the analytic structure 35, but not yet approved. In the preferred embodiments, the pending discussion points always are shown in single-column format in order to help avoid biasing users toward thinking about a pending discussion point in a particular way. Also, in the preferred embodiments, pending discussion points can be informally commented on, e.g., by clicking on the corresponding link 454 or 455 to get to the comment page for the discussion point 451 or 452, respectively, but are not subject to formal analysis (e.g., child discussion points cannot be proposed or created for them and they cannot be rated) unless and until they are approved and become active discussion points. The reason for this preference is that while a discussion point is still in the pending stage, the main goal preferably is not to analyze whether or not it is supported or relevant (although some of those considerations might come up during the informal commenting process), but rather to just put the discussion point into the best possible form before inclusion within the analytic structure 35 (or before determining whether or not it should be included). Therefore, in the preferred embodiments only informal comments and proposed alternate forms are accepted with respect to any pending discussion point. In this regard, an asterisk (*) on the comment page link (e.g., link 454) indicates that at least one alternate form of the corresponding child discussion point has been proposed.

In certain embodiments, radio buttons 457 are provided for the users (or a subset of them, such as only administrators) to indicate whether the pending child discussion point is initially considered to be pro or con relative to the current discussion point 305 (its parent). However, such characterizations are not necessarily static. As new discussion points are added to the analytic structure 35 over time, the pro/con status of a discussion point can be changed.

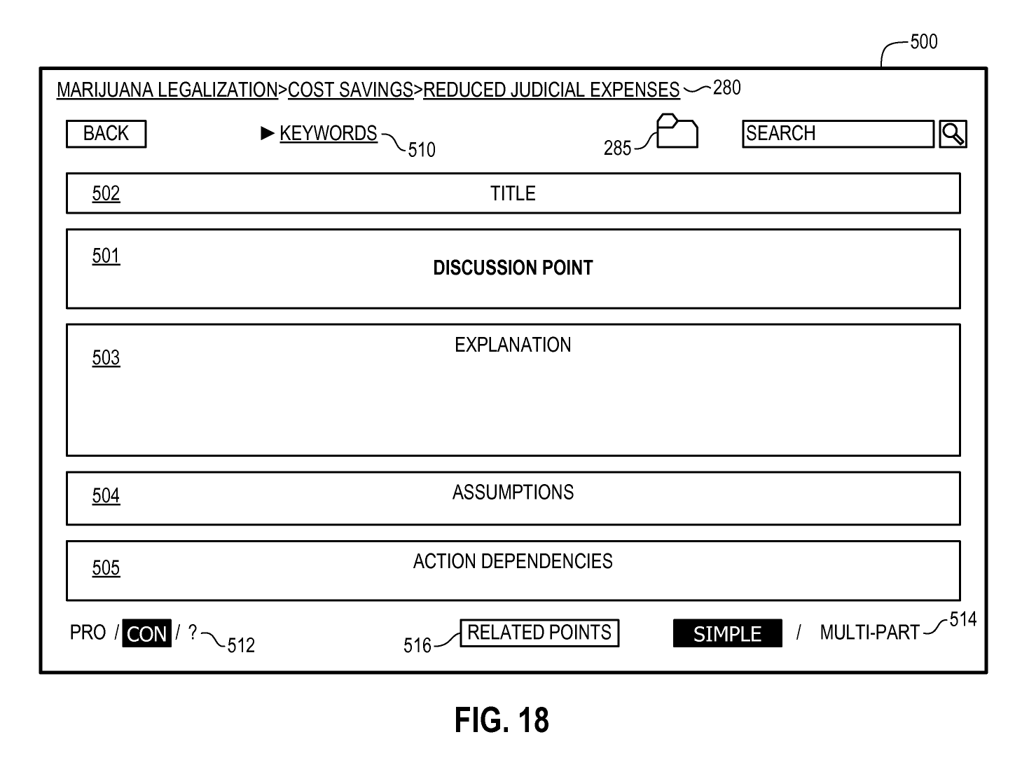

Finally, button 460 preferably links to a page 500 (shown in FIG. 18) for proposing a new child discussion point for the current discussion point 305. Page 500 preferably includes a number of fields for entering all of the information pertaining to the pending discussion point.

For instance, field 501 is where a user can enter a statement of the discussion point itself. In the preferred embodiments, the discussion point is limited in length (e.g., to 200-400 characters maximum) and is desired to be as brief as possible.

Field 502 is where a title which will be included in the navigation map 280 is entered. Preferably, the title is even more limited in length (e.g., to 20-40 characters maximum). It is noted that fields 501 and 502 preferably are the only required fields for creating a new proposed discussion point.

Field 503 is where any additional explanation can be entered. It preferably is either unlimited in length or has a less restrictive maximum length (e.g., 1,000-5,000 characters maximum) and preferably can also include reference links to other nodes in the current analytic structure 35 or other analytic structures, to other materials within the site provided by server 10, or to other materials provided by any other server or device (e.g., anywhere on the Internet). In the preferred embodiments, field 503 also is encouraged to be as brief as possible. If the discussion point 501 involves very complicated concepts or ideas, then it is preferred to explain such concepts in different levels, with each level providing additional detail regarding a specific matter, so that users can drill-down (or zoom-in) on only those matters for which they require additional explanation, thereby accommodating users of all levels of expertise and knowledge in different subject-matter areas, as well as helping to prevent any explanation from becoming too overwhelming.

Field 504 is where any assumptions can be entered. Preferably, each assumption is entered separately, as a separate item, e.g., by entering the text for an assumption then clicking an “Add” button (not shown), and then repeating for each additional assumption. An assumption generally is a statement whose validity affects the validity of the discussion point to which it is linked (e.g., where the discussion point is only true if the assumption also is true). Relevance, with respect to an assumption, preferably is an estimation as to how much the validity of the assumption affects the validity of the discussion point to which it is linked. As each such assumption is added, a new node preferably is added into the analytic structure 35 to include the assumption, and an assumption link is established between the pending discussion point node and the node that has been created for the new assumption. As indicated above, each assumption node preferably can be analyzed within the analytic structure 35 in the same (or much the same) way as a discussion point node, e.g., with regard to both support and relevance.

More generally, in the preferred embodiments of system 5, each statement within the formal analysis is encapsulated within a node. The meaning of each statement can vary depending upon the context in which it is used (e.g., a standalone discussion point, an assumption, and action dependency, explanation, etc.), and a single statement can have different meanings in different contexts. Preferably, these different meanings are identified based on the kinds of links that join different nodes together (e.g., support links, assumption links, action dependency links, explanation links, etc.).

Field 505 is where any action dependencies can be entered. Similar to assumptions, in the preferred embodiments each action dependency is entered separately, as a separate item, e.g., by entering the text for an action dependency then clicking an “Add” button (not shown), and then repeating for each additional action dependency. An action dependency generally is the statement of an action whose occurrence affects the validity of the discussion point to which it is linked. Relevance, with respect to an action dependency, preferably is an estimation as to how much the occurrence of the action dependency affects the validity of the discussion point. As each such action dependency is added, a new node preferably is added into the analytic structure 35 to include the action dependency, and an action dependency link is established between the pending discussion point node and the action dependency node. Each action dependency node preferably can be analyzed within the analytic structure 35 as to relevance and as to support, in this case meaning whether or not it is advisable to take the described action (e.g., because it may have other consequences beyond those that affect the current discussion point).

Clicking on keywords link 510 preferably causes a pop-up box to be displayed into which keywords can be entered. Such keywords can be useful for characterizing the discussion point, which can then be later used when users are searching using the search box 150 (e.g., to find discussion points that are related to something they are currently interested in analyzing).

Radio buttons 512 allow the user to characterize the discussion point 501 as pro, con or currently undecided (represented by “?”).

Radio buttons 514 allow the user to characterize the discussion point 501 as a simple or multi-part discussion point. In this regard, in the preferred embodiments both issues and discussion points can be characterized in this way. A simple discussion point (or issue) is one that can be analyzed in a pro/con manner, i.e., as to whether it is true or not (or in the case of the question, as to whether the answer is yes or no). On the other hand, when a discussion point (or issue) is characterized as multi-part, it preferably is treated more as a category, in which its child discussion points are different potential answers (if it is an issue) or are different related discussion points (if it is a discussion point). Often, the top-level child discussion points underneath a multi-part issue or discussion point will share some aspects of their analyses (e.g., some common discussion point nodes).

Clicking on related points link 516 preferably causes a pop-up box to be displayed into which related discussion points can be identified. Doing so might be desirable, e.g., where a user is aware of a similar, but not identical, discussion point which may be useful to review in analyzing or just thinking about the current discussion point. Identifying a related discussion point in this manner preferably causes a related-node link to be created in the analytic structure 35. One technique for specifying related nodes is as follows.

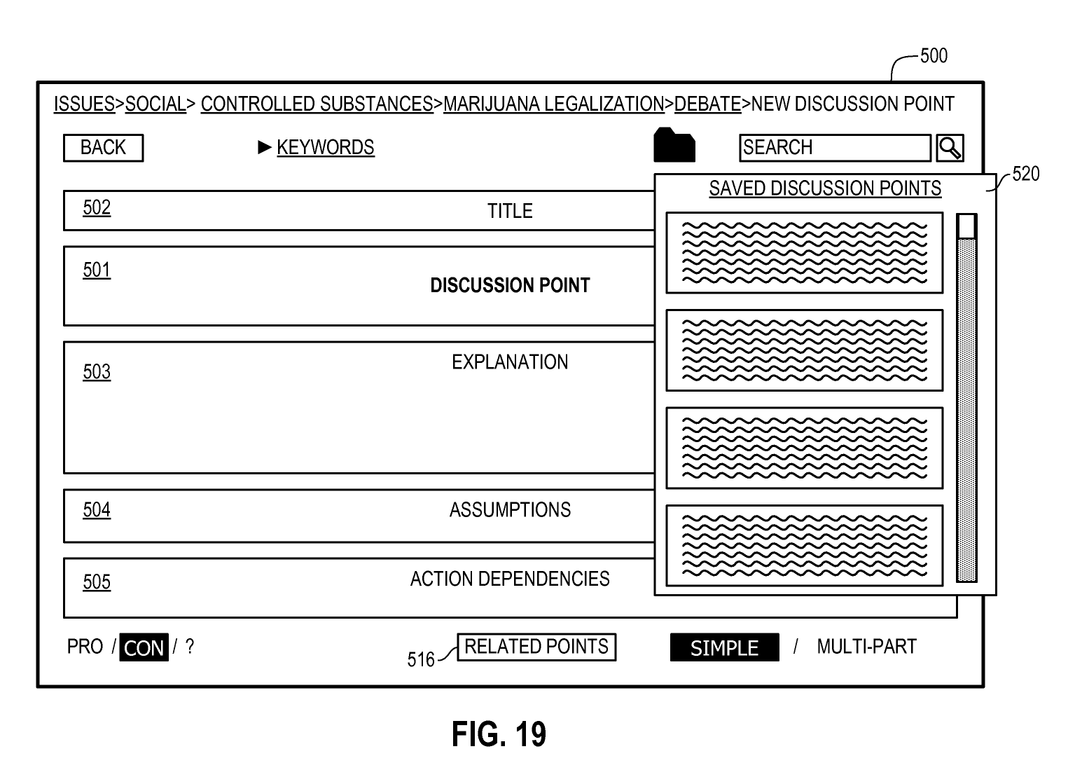

Certain approaches for storing links to discussion point nodes and other kinds of nodes into folder 285 were discussed above. These stored links often can be very useful when creating a new pending discussion point. In the preferred embodiments, clicking on folder 285 causes a pop-up box 520 (as shown in FIG. 19) to be displayed. Pop-up box 520 shows the statements (which could be, e.g., discussion points, assumptions, action dependencies or explanations) for which links previously had been saved by the particular user who is creating a proposed discussion point. Then, dragging one of the statements into the assumptions field 504 preferably makes it a new assumption, dragging one of them into the action dependencies field 505 preferably makes it a new action dependency, dragging one of them into the explanation field 503 preferably creates a link at the point where it was dragged, inline with the other text of the explanation, so it can serve as a reference link, and dragging one of them to the related points link 516 or its associated pop-up box preferably creates a new related discussion point for the current discussion point 501. In this way, new links (e.g., of any desired type) can be created to existing nodes within the present analytic structure 35 or any other analytic structure.

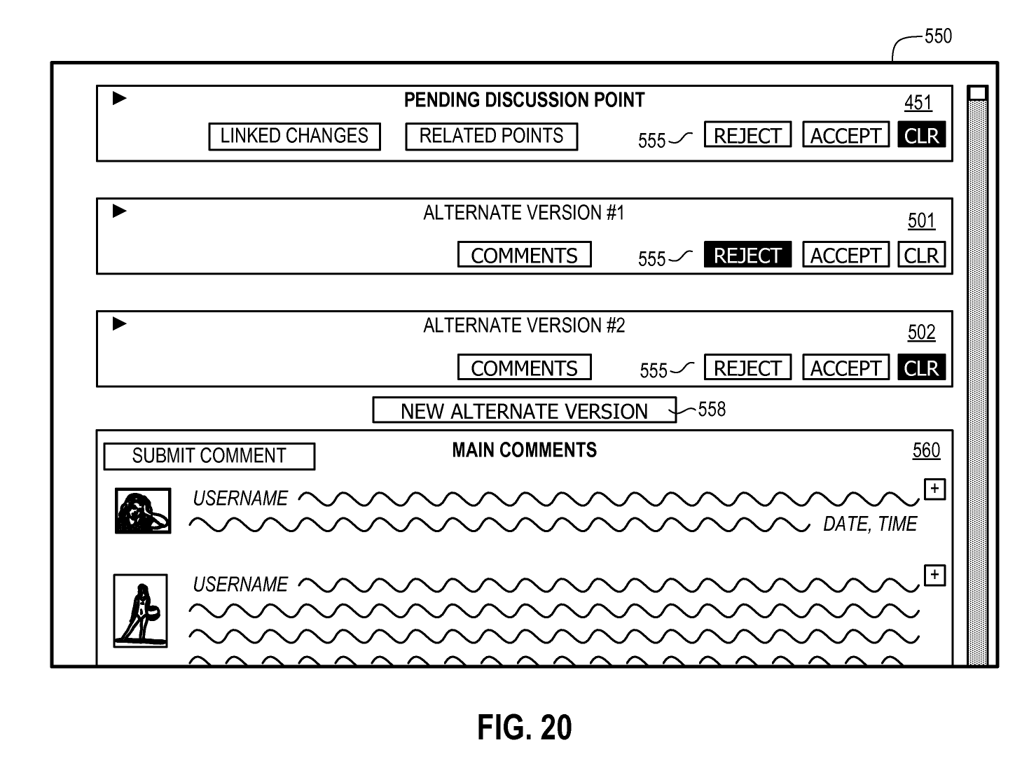

FIG. 20 illustrates a representative page 550 that might be displayed after clicking on one of the comments link 454, shown in FIG. 17 for pending discussion point 451. A similar page (or similar content) can be displayed for an active discussion point when viewing its comments, but it generally will be much rarer to have alternate versions of an active discussion point because active discussion points typically already will have been fairly well vetted.

At the top of page 550 is the pending discussion point 451. Underneath that are certain alternate versions 551 and 552 of it that have been proposed. Often, these alternate versions will, e.g., attempt to make the language clearer or more concise, correct some minor error, add an additional assumption or action dependency, or make some other changes in an attempt to put the discussion point in the best condition possible. Preferably, some or all of the users (e.g., just the administrators 12) also have the ability to vote on which, if any, version should be included within the analytic structure 35 (i.e., elevated to active status). In the present example, each version of the discussion point includes radio buttons 555 for which the user can select “reject”, meaning that it should not be considered (typically because a better version has been proposed), “accept”, meaning that the subject version is acceptable to become an active discussion point, or “clr”, meaning that the previous selection should be cleared.

Underneath the pending discussion point 451 and any proposed alternate versions 551 and 552 of it is a link 558 to a page for creating a new proposed alternate version of discussion point 451. In the preferred embodiments, this page is identical to page 500 (discussed above), but pre-populated with the information from discussion point 451 (or any of the existing proposed alternate versions 551 and 552 of it that has been selected by the user), so that the user can simply make any desired changes and keep everything else. Finally, underneath link 558 is a section of comments 560 pertaining to pending discussion point 451 and/or to any of the proposed alternate versions 551 and 552 of it. Preferably, the same considerations that apply to comments section 173 (discussed above) also apply to comments section 560.

In addition, the administrators 12 (and, in certain embodiments, at least some of the general participants 14) preferably are provided with the functionality to cut, copy, paste and move individual comments or selections of comments. Such functionality can be useful, e.g., where an idea originates in the comments for a particular discussion point and that idea ultimately results in a new child discussion point being created. In such a case, the comments pertaining to that child discussion point preferably are copied or moved from the parent to the child.

### Interactions and Distributions of Functionality.

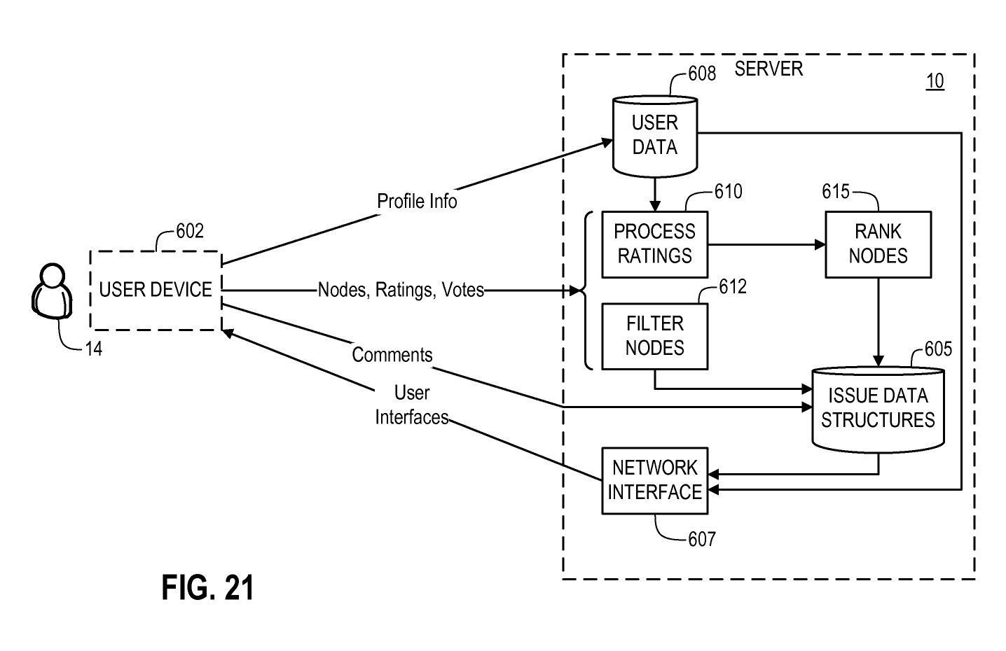

FIG. 21 illustrates the distribution of functionality, and shows certain interactions between an individual participant 14 and the server 10, within system 5, according to a representative embodiment of the present invention. Generally speaking, each participant 14 involved with the system 5 can interact with server 10 through his or her respective user device 602 in any of the ways described below. In the present specific example, user device 602 interacts with server 10 exclusively through a web browser, and nearly all of the functionality is performed by server 10. However, it should be understood that the functionality described herein can be distributed in any desired manner between server 10 and the individual user devices 602, e.g., using a special-purpose application running on the user devices 602. In any event, in the preferred embodiments all of the user interfaces described herein are provided by the server 10, either directly as Web pages or indirectly by providing an application to the user devices 602 that generates at least some portion of such interfaces.

As shown, in the present embodiment server 10 includes a storage device 605 (e.g., including one or more hard drives) that stores a plurality of analytic data structures (similar to structure 35 discussed above). Typically, there will be at least 10, 25, 50, 100, 500, 1,000 or even more such analytic data structures, each pertaining to a different issue. In addition, each such analytic structure may have been built through the efforts of at least 10, 25, 50, 100, 500, 1,000 or even more different participants 14 (e.g., submitting nodes, ratings, votes and/or comments for the analytic data structure as a whole or for any given node within it).

Network interface 607 generates and provides the user interfaces (e.g., Web pages, such as those described above) to the various user devices 602 based on the data structures, rating information and node ranking information previously stored in storage device 605 and user profile information previously stored in user data storage device 608. Based on these user interfaces, the user (participant 14) through his or her device 602 submits a variety of different information to server 10. Although all such information submissions typically would be managed by network interface 607, that intermediate step is omitted in FIG. 21 to enhance clarity.

User profile information provided by participant 14 is stored in storage device 608, e.g., for use in generating user interfaces (by module 607), identifying the user for purposes of weighting his or her ratings (by module 610), and in some cases matching the user to a subset of the entire community 15 for use in generating user-specific composite ratings and corresponding rankings of nodes. Submissions of nodes, node ratings and voting preferences are submitted to the ratings-processing module 610, e.g., for generating composite and/or derived rating values, and to node-filtering module 612, e.g., for determining which pending nodes would be made active. Comments provided by participant 14 typically are stored directly into storage device 605, without any processing (although the administrators 12 preferably have the ability to delete or modify any comments that are not in accordance with the site's rules and regulations).

As shown in FIG. 21, the processed ratings information are provided to node-ranking module 615 which, e.g., ranks each set of sibling nodes within each of the analytic data structures for purposes of display (by interface 607) based on their relative significances. Implementation of the functionality performed by modules 607, 610, 612 and 615 has been described in detail above.

### System Environment.

Generally speaking, except where clearly indicated otherwise, all of the systems, methods, functionality and techniques described herein can be practiced with the use of one or more programmable general-purpose computing devices. Such devices typically will include, for example, at least some of the following components interconnected with each other, e.g., via a common bus: one or more central processing units (CPUs); read-only memory (ROM); random access memory (RAM); input/output software and circuitry for interfacing with other devices (e.g., using a hardwired connection, such as a serial port, a parallel port, a USB connection or a FireWire connection, or using a wireless protocol, such as Bluetooth or a 802.11 protocol); software and circuitry for connecting to one or more networks, e.g., using a hardwired connection such as an Ethernet card or a wireless protocol, such as code division multiple access (CDMA), global system for mobile communications (GSM), Bluetooth, a 802.11 protocol, or any other cellular-based or non-cellular-based system, which networks, in turn, in many embodiments of the invention, connect to the Internet or to any other networks; a display (such as a cathode ray tube display, a liquid crystal display, an organic light-emitting display, a polymeric light-emitting display or any other thin-film display); other output devices (such as one or more speakers, a headphone set and a printer); one or more input devices (such as a mouse, touchpad, tablet, touch-sensitive display or other pointing device, a keyboard, a keypad, a microphone and a scanner); a mass storage unit (such as a hard disk drive or a solid-state drive); a real-time clock; a removable storage read/write device (such as for reading from and writing to RAM, a magnetic disk, a magnetic tape, an opto-magnetic disk, an optical disk, or the like); and a modem (e.g., for sending faxes or for connecting to the Internet or to any other computer network via a dial-up connection). In operation, the process steps to implement the above methods and functionality, to the extent performed by such a general-purpose computer, typically initially are stored in mass storage (e.g., a hard disk or solid-state drive), are downloaded into RAM, and then are executed by the CPU out of RAM. However, in some cases the process steps initially are stored in RAM or ROM.

Suitable general-purpose programmable devices for use in implementing the present invention may be obtained from various vendors. In the various embodiments, different types of devices are used depending upon the size and complexity of the tasks. Such devices can include, e.g., mainframe computers, multiprocessor computers, workstations, personal (e.g., desktop, laptop, tablet or slate) computers and/or even smaller computers, such as PDAs, wireless telephones or any other programmable appliance or device, whether stand-alone, hard-wired into a network or wirelessly connected to a network.

In addition, although general-purpose programmable devices have been described above, in alternate embodiments one or more special-purpose processors or computers instead (or in addition) are used. In general, it should be noted that, except as expressly noted otherwise, any of the functionality described above can be implemented by a general-purpose processor executing software and/or firmware, by dedicated (e.g., logic-based) hardware, or any combination of these, with the particular implementation being selected based on known engineering tradeoffs. More specifically, where any process and/or functionality described above is implemented in a fixed, predetermined and/or logical manner, it can be accomplished by a processor executing programming (e.g., software or firmware), an appropriate arrangement of logic components (hardware), or any combination of the two, as will be readily appreciated by those skilled in the art. In other words, it is well-understood how to convert logical and/or arithmetic operations into instructions for performing such operations within a processor and/or into logic gate configurations for performing such operations; in fact, compilers typically are available for both kinds of conversions.

It should be understood that the present invention also relates to machine-readable tangible (or non-transitory) media on which are stored software or firmware program instructions (i.e., computer-executable process instructions) for performing the methods and functionality of this invention. Such media include, by way of example, magnetic disks, magnetic tape, optically readable media such as CDs and DVDs, or semiconductor memory such as various types of memory cards, USB flash memory devices, solid-state drives, etc. In each case, the medium may take the form of a portable item such as a miniature disk drive or a small disk, diskette, cassette, cartridge, card, stick etc., or it may take the form of a relatively larger or less-mobile item such as a hard disk drive, ROM or RAM provided in a computer or other device. As used herein, unless clearly noted otherwise, references to computer-executable process steps stored on a computer-readable or machine-readable medium are intended to encompass situations in which such process steps are stored on a single medium, as well as situations in which such process steps are stored across multiple media.

The foregoing description primarily emphasizes electronic computers and devices. However, it should be understood that any other computing or other type of device instead may be used, such as a device utilizing any combination of electronic, optical, biological and chemical processing that is capable of performing basic logical and/or arithmetic operations.

In addition, where the present disclosure refers to a processor, computer, server device, computer-readable medium or other storage device, client device, or any other kind of device, such references should be understood as encompassing the use of plural such processors, computers, server devices, computer-readable media or other storage devices, client devices, or any other devices, except to the extent clearly indicated otherwise. For instance, a server generally can be implemented using a single device or a cluster of server devices (either local or geographically dispersed), e.g., with appropriate load balancing.

### Additional Considerations.

In the event of any conflict or inconsistency between the disclosure explicitly set forth herein or in the attached drawings, on the one hand, and any materials incorporated by reference herein, on the other, the present disclosure shall take precedence. In the event of any conflict or inconsistency between the disclosures of any applications or patents incorporated by reference herein, the more recently filed disclosure shall take precedence.

In certain instances, the foregoing description refers to clicking or double-clicking on user-interface buttons, dragging user-interface items, or otherwise entering commands or information via a particular user-interface mechanism and/or in a particular manner. All of such references are intended to be exemplary only, it being understood that the present invention encompasses entry of the corresponding commands or information by a user in any other manner using the same or any other user-interface mechanism. In addition, or instead, such commands or information may be input by an automated (e.g., computer-executed) process.

Several different embodiments of the present invention are described above, with each such embodiment described as including certain features. However, it is intended that the features described in connection with the discussion of any single embodiment are not limited to that embodiment but may be included and/or arranged in various combinations in any of the other embodiments as well, as will be understood by those skilled in the art.

Similarly, in the discussion above, functionality sometimes is ascribed to a particular module, component or user interface. However, functionality generally may be redistributed as desired among any different modules, components or user interfaces, in some cases completely obviating the need for a particular component, module or user interface and/or requiring the addition of new components or modules. The precise distribution of functionality preferably is made according to known engineering tradeoffs, with reference to the specific embodiment of the invention, as will be understood by those skilled in the art.

Thus, although the present invention has been described in detail with regard to the exemplary embodiments thereof and accompanying drawings, it should be apparent to those skilled in the art that various adaptations and modifications of the present invention may be accomplished without departing from the spirit and the scope of the invention. Accordingly, the invention is not limited to the precise embodiments shown in the drawings and described above. Rather, it is intended that all such variations not departing from the spirit of the invention be considered as within the scope thereof as limited solely by the claims appended hereto.

1. A system for analyzing issues, comprising:
(a) a server providing an interactive site on a communications network; and
(b) a plurality of user devices communicating with the server across the communications network,
wherein the server stores a plurality of data structures, each including hierarchically arranged active nodes that together present analysis information pertaining to a different issue,
wherein each of the data structures includes a top active node that includes a statement of the issue to which said data structure pertains,
wherein users, through the user devices, submit proposed additional nodes to the server,
wherein each of a plurality of said proposed additional nodes is submitted as a potential child node to a previously existing active node in one of the data structures and includes a corresponding proposed new discussion point statement with an argument for or against a statement made in said previously existing active node, and
wherein the server accepts at least a subset of the proposed additional nodes to be added as active nodes, thereby extending the corresponding hierarchical structures.

2. A system according to claim 1, wherein the users, through the user devices, submit ratings of the discussion point statements within the active nodes, including previously proposed additional nodes that have been added as active nodes.

3. A system according to claim 2, wherein the ratings include support ratings, and each said support rating indicates a degree to which the discussion point statement in the corresponding active node is believed to be true.

4. A system according to claim 2, wherein the ratings include relevance ratings, and each said relevance rating indicates a degree to which the discussion point statement in the corresponding active node is believed to be relevant to the discussion point statement or issue statement in a parent node for which the corresponding active node is a child node.

5. A system according to claim 2, wherein the server combines individual ratings for the discussion point statement within a single active node that have been received from different ones of the users for said single active node into a composite rating.

6. A system according to claim 5, wherein the server combines said individual ratings for the discussion point statement within said single active node using a weighted average, with the individual ratings being weighted based on participation levels assigned to the users who submitted them.

7. A system according to claim 5, wherein the server repeats said combining step for each of a plurality of different active nodes at a same hierarchical level in one of the data structures to produce a composite rating for each of said different active nodes and then displays the discussion point statements within the plurality of different active nodes sorted into an order that is based on said composite ratings.

8. A system according to claim 2, wherein at least 500 different users submit ratings for the discussion point statement within a particular active node.

9. A system according to claim 1, wherein the server accepts the proposed additional nodes to be added as active nodes in accordance with a specified criterion that comprises receipt of approval from an administrative user.

10. A system according to claim 1, wherein the server accepts the proposed additional nodes to be added as active nodes in accordance with a specified criterion that comprises satisfaction of a predesignated voting requirement across at least 20 users.

11. A system according to claim 1, wherein users, through the user devices, have an ability to submit proposed alternate versions of the proposed new discussion point statements to the server as part of the vetting process.

12. A system according to claim 1, wherein links exist between nodes in different ones of the data structures.

13. A system according to claim 1, wherein the communications network comprises the Internet.

14. A system according to claim 1, wherein at least 100 users participate in constructing each of at least 25 different ones of the data structures.

15. A system according to claim 1, wherein at least one of said proposed additional nodes also identifies an assumption which is indicated as being required to be true in order for the discussion point statement within said at least one proposed additional node to be true, and wherein the assumption is configured as a node for which proposed child nodes, each including a discussion point statement pertaining to said assumption, may be submitted.

16. A system according to claim 6, wherein the participation levels are based on amount and quality of participation.

17. A system according to claim 1, wherein the discussion point statements in the potential child nodes are limited to a maximum number of characters, said maximum being within a range of 200-400 characters.

18. A system according to claim 1, wherein the server also provides, upon receiving a request with respect to any one of the active nodes, a user interface for said requested active node that displays: the issue or discussion point statement within said requested active node, a plurality of the discussion point statements within the child nodes of the requested active node, and at least one of (i) a comments section where the users can submit informal comments regarding the issue statement or discussion point statement within said requested active node, or (ii) a link to said comments section.

19. A system according to claim 18, wherein the discussion point statements within the child nodes of the requested active node are displayed in two columns, with only pro discussion point statements in a first column and with only con discussion point statements in a second column.

20. A system according to claim 19, wherein within each of the first and second column, the discussion point statements within the child nodes of the requested active node are displayed in an order based on at least one of: (i) how well each said child-node discussion point statement is supported, or (ii) how relevant to the issue or discussion point in the requested active node each said child-node discussion point statement is.

21. A system according to claim 4, wherein each said relevance rating also indicates whether the discussion point statement in the corresponding active node supports or refutes the discussion point statement or issue statement in the parent node for which the corresponding active node is said child node.

22. A system according to claim 1, wherein the discussion point statements in the potential child nodes are limited to a maximum number of characters.

23. A system according to claim 18, wherein the discussion point statements within the child nodes of the requested active node are displayed in an order based on a combination of: (i) how well each said child-node discussion point statement is supported, and (ii) how relevant to the issue or discussion point in the requested active node each said child-node discussion point statement is.

24. A system according to claim 19, wherein within each of the first and second column, the discussion point statements within the child nodes of the requested active node are displayed in an order based on a combination of: (i) how well each said child-node discussion point statement is supported, and (ii) how relevant to the issue or discussion point in the requested active node each said child-node discussion point statement is.

25. A system according to claim 3, wherein the server combines individual support ratings for the discussion point statement within a single active node that have been received from different ones of the users for said single active node into a composite support rating.

26. A system according to claim 25, wherein the server repeats said combining step for each of a plurality of different active nodes at a same hierarchical level in one of the data structures to produce a composite support rating for each of said different active nodes and then displays the discussion point statements within the plurality of different active nodes sorted into an order that is based on said composite support ratings.

27. A system according to claim 1, wherein the proposed new discussion point within each of said plurality of proposed additional nodes includes at least one of a specific factual point or reasoned analytical support.
